(19) United States
(12) Patent Application Publication
(10) Pub. No.: US 2026/0229001 A1
(43) Pub. Date: Aug. 6, 2026

(54) TECHNIQUES FOR INTERACTING WITH DEVICES

(71) Applicant: Apple Inc., Cupertino, CA (US)

(72) Inventors: Shivesh MAKHARIA, Los Gatos, CA (US); Christopher J. LEE, Los Altos, CA (US)

(21) Appl. No.: 19/427,828

(22) Filed: Dec. 19, 2025

Related U.S. Application Data
(60) Provisional application No. 63/754,392, filed on Feb. 5, 2025.

(51) Int. Cl. G06V 10/25; H04N 23/611

(52) U.S. Cl. CPC G06V 10/25; H04N 23/611; G06V 2201/07

(57) ABSTRACT

The present disclosure generally relates to performing operations based on an environment. Some techniques are for providing a portion of accessory information to a background process in accordance with some embodiments. Other techniques are for enabling a service based on a detected subject in accordance with some embodiments. Other techniques are for altering a state of a set of external devices based on an emergency condition in accordance with some embodiments. Other techniques are for outputting audio based on activity within an area in accordance with some embodiments.

### CROSS-REFERENCE TO RELATED APPLICATIONS

This application claims priority to U.S. Provisional Patent Application Serial No. 63/754,392, entitled “TECHNIQUES FOR INTERACTING WITH DEVICES,” filed February 5, 2025. The content of this application is hereby incorporated by reference in its entirety.

### BACKGROUND

Electronic devices are becoming increasingly interconnected. For example, accessory devices are often configured to form an ecosystem of accessory devices (e.g., speakers, fans, lights, thermostats, and/or locks) within a home. Securely interacting with these accessory devices has become increasingly difficult as accessory devices require more information and outside connections to provide functionality. Accordingly, there is a need to improve techniques for performing operations based on an environment.

### SUMMARY

Current techniques for performing operations based on an environment are generally ineffective and/or inefficient. For example, some techniques require users to interact with multiple applications to monitor and access functionality provided by accessory devices. This disclosure provides more effective and/or efficient techniques for performing operations based on an environment using examples of a resident device controlling accessory devices. It should be recognized that other types of electronic devices can be used with techniques described herein. For example, a smartphone can control accessory devices using techniques described herein. In addition, techniques optionally complement or replace other techniques for performing operations based on an environment.

Some techniques are described herein for transmitting accessory device information to a server through the use of a background process. For example, an accessory management application can initiate a background process of another application to facilitate communication of information to a server without requiring initiation of the other application. Other techniques are described here for enabling services based on a person’s presence within an environment. For example, a device can enable one or more content streaming services for a subject interacting with the device based on another subject being present in an area where the device is situated without requiring lengthy login procedures. Other techniques are described here for changing a state of one or more accessory devices based on a condition within an environment. For example, a device can turn on a set of light accessory devices within a living room based on the device detecting an unknown person outside of a window of the living room. Other techniques are described here for selectively outputting audio of an area within an environment while displaying another source of content. For example, a display device can switch between movie audio and camera audio received from another room while users enjoy a movie to allow the users to monitor the other room.

In some embodiments, a method that is performed at a first device, by an accessory management application is described. In some embodiments, the method comprises: initiating a background process corresponding to another application separate from the accessory management application; receiving, from a second device separate from the first device, first accessory device information; and in response to receiving the first accessory device information: in accordance with a determination that a first portion of the first accessory device information satisfies a set of one or more criteria and that a second portion of the first accessory device information does not satisfy the set of one or more criteria, providing, to the background process corresponding to the other application, the first portion of the first accessory device information without providing, to the background process corresponding to the other application, the second portion of the first accessory device information, wherein the second portion is different from the first portion; and in accordance with a determination that the second portion of the first accessory device information satisfies the set of one or more criteria and that the first portion of the first accessory device information does not satisfy the set of one or more criteria, providing, to the background process corresponding to the other application, the second portion of the first accessory device information without providing, to the background process corresponding to the other application, the first portion of the first accessory device information.

In some embodiments, a non-transitory computer-readable storage medium storing one or more programs configured to be executed by one or more processors of a first device, by an accessory management application is described. In some embodiments, the one or more programs includes instructions for: initiating a background process corresponding to another application separate from the accessory management application; receiving, from a second device separate from the first device, first accessory device information; and in response to receiving the first accessory device information: in accordance with a determination that a first portion of the first accessory device information satisfies a set of one or more criteria and that a second portion of the first accessory device information does not satisfy the set of one or more criteria, providing, to the background process corresponding to the other application, the first portion of the first accessory device information without providing, to the background process corresponding to the other application, the second portion of the first accessory device information, wherein the second portion is different from the first portion; and in accordance with a determination that the second portion of the first accessory device information satisfies the set of one or more criteria and that the first portion of the first accessory device information does not satisfy the set of one or more criteria, providing, to the background process corresponding to the other application, the second portion of the first accessory device information without providing, to the background process corresponding to the other application, the first portion of the first accessory device information.

In some embodiments, a transitory computer-readable storage medium storing one or more programs configured to be executed by one or more processors of a first device, by an accessory management application is described. In some embodiments, the one or more programs includes instructions for: initiating a background process corresponding to another application separate from the accessory management application; receiving, from a second device separate from the first device, first accessory device information; and in response to receiving the first accessory device information: in accordance with a determination that a first portion of the first accessory device information satisfies a set of one or more criteria and that a second portion of the first accessory device information does not satisfy the set of one or more criteria, providing, to the background process corresponding to the other application, the first portion of the first accessory device information without providing, to the background process corresponding to the other application, the second portion of the first accessory device information, wherein the second portion is different from the first portion; and in accordance with a determination that the second portion of the first accessory device information satisfies the set of one or more criteria and that the first portion of the first accessory device information does not satisfy the set of one or more criteria, providing, to the background process corresponding to the other application, the second portion of the first accessory device information without providing, to the background process corresponding to the other application, the first portion of the first accessory device information.

In some embodiments, a first device, by an accessory management application is described. In some embodiments, the first device, comprises one or more processors and memory storing one or more programs configured to be executed by the one or more processors. In some embodiments, the one or more programs includes instructions for: initiating a background process corresponding to another application separate from the accessory management application; receiving, from a second device separate from the first device, first accessory device information; and in response to receiving the first accessory device information: in accordance with a determination that a first portion of the first accessory device information satisfies a set of one or more criteria and that a second portion of the first accessory device information does not satisfy the set of one or more criteria, providing, to the background process corresponding to the other application, the first portion of the first accessory device information without providing, to the background process corresponding to the other application, the second portion of the first accessory device information, wherein the second portion is different from the first portion; and in accordance with a determination that the second portion of the first accessory device information satisfies the set of one or more criteria and that the first portion of the first accessory device information does not satisfy the set of one or more criteria, providing, to the background process corresponding to the other application, the second portion of the first accessory device information without providing, to the background process corresponding to the other application, the first portion of the first accessory device information.

In some embodiments, a first device, by an accessory management application is described. In some embodiments, the first device, comprises means for performing each of the following steps: initiating a background process corresponding to another application separate from the accessory management application; receiving, from a second device separate from the first device, first accessory device information; and in response to receiving the first accessory device information: in accordance with a determination that a first portion of the first accessory device information satisfies a set of one or more criteria and that a second portion of the first accessory device information does not satisfy the set of one or more criteria, providing, to the background process corresponding to the other application, the first portion of the first accessory device information without providing, to the background process corresponding to the other application, the second portion of the first accessory device information, wherein the second portion is different from the first portion; and in accordance with a determination that the second portion of the first accessory device information satisfies the set of one or more criteria and that the first portion of the first accessory device information does not satisfy the set of one or more criteria, providing, to the background process corresponding to the other application, the second portion of the first accessory device information without providing, to the background process corresponding to the other application, the first portion of the first accessory device information.

In some embodiments, a computer program product is described. In some embodiments, the computer program product comprises one or more programs configured to be executed by one or more processors of a first device, by an accessory management application. In some embodiments, the one or more programs include instructions for: initiating a background process corresponding to another application separate from the accessory management application; receiving, from a second device separate from the first device, first accessory device information; and in response to receiving the first accessory device information: in accordance with a determination that a first portion of the first accessory device information satisfies a set of one or more criteria and that a second portion of the first accessory device information does not satisfy the set of one or more criteria, providing, to the background process corresponding to the other application, the first portion of the first accessory device information without providing, to the background process corresponding to the other application, the second portion of the first accessory device information, wherein the second portion is different from the first portion; and in accordance with a determination that the second portion of the first accessory device information satisfies the set of one or more criteria and that the first portion of the first accessory device information does not satisfy the set of one or more criteria, providing, to the background process corresponding to the other application, the second portion of the first accessory device information without providing, to the background process corresponding to the other application, the first portion of the first accessory device information.

In some embodiments, a method that is performed at a computer system that is in communication with one or more input devices and one or more display generation components is described. In some embodiments, the method comprises: detecting, via the one or more input devices, a first subject within an area; while detecting the first subject within the area, displaying, via the one or more display generation components, content corresponding to the first subject; while displaying the content corresponding to the first subject, detecting, via the one or more input devices, a second subject within the area, wherein the second subject is different from the first subject; and in response to detecting the second subject within the area and while maintaining display of the content corresponding to the first subject, enabling, using a credential for the second subject, a service.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: detecting, via the one or more input devices, a first subject within an area; while detecting the first subject within the area, displaying, via the one or more display generation components, content corresponding to the first subject; while displaying the content corresponding to the first subject, detecting, via the one or more input devices, a second subject within the area, wherein the second subject is different from the first subject; and in response to detecting the second subject within the area and while maintaining display of the content corresponding to the first subject, enabling, using a credential for the second subject, a service.

In some embodiments, a transitory computer-readable storage medium storing one or more programs configured to be executed by one or more processors of a computer system that is in communication with one or more input devices and one or more display generation components is described. In some embodiments, the one or more programs includes instructions for: detecting, via the one or more input devices, a first subject within an area; while detecting the first subject within the area, displaying, via the one or more display generation components, content corresponding to the first subject; while displaying the content corresponding to the first subject, detecting, via the one or more input devices, a second subject within the area, wherein the second subject is different from the first subject; and in response to detecting the second subject within the area and while maintaining display of the content corresponding to the first subject, enabling, using a credential for the second subject, a service.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: detecting, via the one or more input devices, a first subject within an area; while detecting the first subject within the area, displaying, via the one or more display generation components, content corresponding to the first subject; while displaying the content corresponding to the first subject, detecting, via the one or more input devices, a second subject within the area, wherein the second subject is different from the first subject; and in response to detecting the second subject within the area and while maintaining display of the content corresponding to the first subject, enabling, using a credential for the second subject, a service.

In some embodiments, a computer system configured to communicate with one or more input devices and one or more display generation components is described. In some embodiments, the computer system comprises means for performing each of the following steps: detecting, via the one or more input devices, a first subject within an area; while detecting the first subject within the area, displaying, via the one or more display generation components, content corresponding to the first subject; while displaying the content corresponding to the first subject, detecting, via the one or more input devices, a second subject within the area, wherein the second subject is different from the first subject; and in response to detecting the second subject within the area and while maintaining display of the content corresponding to the first subject, enabling, using a credential for the second subject, a service.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: detecting, via the one or more input devices, a first subject within an area; while detecting the first subject within the area, displaying, via the one or more display generation components, content corresponding to the first subject; while displaying the content corresponding to the first subject, detecting, via the one or more input devices, a second subject within the area, wherein the second subject is different from the first subject; and in response to detecting the second subject within the area and while maintaining display of the content corresponding to the first subject, enabling, using a credential for the second subject, a service.

In some embodiments, a method that is performed at a computer system is described. In some embodiments, the method comprises: detecting an emergency condition; and in response to detecting the emergency condition: in accordance with a determination that the emergency condition satisfies a first set of one or more criteria, changing a state of a first set of one or more external devices; and in accordance with a determination that the emergency condition satisfies a second set of one or more criteria, changing a state of a second set of one or more external devices without changing the state of the first set of one or more external devices, wherein the second set of one or more external devices is different from the first set of one or more external devices, and wherein the second set of one or more criteria is different from the first set of one or more criteria.

In some embodiments, a non-transitory computer-readable storage medium storing one or more programs configured to be executed by one or more processors of a computer system is described. In some embodiments, the one or more programs includes instructions for: detecting an emergency condition; and in response to detecting the emergency condition: in accordance with a determination that the emergency condition satisfies a first set of one or more criteria, changing a state of a first set of one or more external devices; and in accordance with a determination that the emergency condition satisfies a second set of one or more criteria, changing a state of a second set of one or more external devices without changing the state of the first set of one or more external devices, wherein the second set of one or more external devices is different from the first set of one or more external devices, and wherein the second set of one or more criteria is different from the first set of one or more criteria.

In some embodiments, a transitory computer-readable storage medium storing one or more programs configured to be executed by one or more processors of a computer system is described. In some embodiments, the one or more programs includes instructions for: detecting an emergency condition; and in response to detecting the emergency condition: in accordance with a determination that the emergency condition satisfies a first set of one or more criteria, changing a state of a first set of one or more external devices; and in accordance with a determination that the emergency condition satisfies a second set of one or more criteria, changing a state of a second set of one or more external devices without changing the state of the first set of one or more external devices, wherein the second set of one or more external devices is different from the first set of one or more external devices, and wherein the second set of one or more criteria is different from the first set of one or more criteria.

In some embodiments, a computer system is described. In some embodiments, the computer system comprises one or more processors and memory storing one or more programs configured to be executed by the one or more processors. In some embodiments, the one or more programs includes instructions for: detecting an emergency condition; and in response to detecting the emergency condition: in accordance with a determination that the emergency condition satisfies a first set of one or more criteria, changing a state of a first set of one or more external devices; and in accordance with a determination that the emergency condition satisfies a second set of one or more criteria, changing a state of a second set of one or more external devices without changing the state of the first set of one or more external devices, wherein the second set of one or more external devices is different from the first set of one or more external devices, and wherein the second set of one or more criteria is different from the first set of one or more criteria.

In some embodiments, a computer system is described. In some embodiments, the computer system comprises means for performing each of the following steps: detecting an emergency condition; and in response to detecting the emergency condition: in accordance with a determination that the emergency condition satisfies a first set of one or more criteria, changing a state of a first set of one or more external devices; and in accordance with a determination that the emergency condition satisfies a second set of one or more criteria, changing a state of a second set of one or more external devices without changing the state of the first set of one or more external devices, wherein the second set of one or more external devices is different from the first set of one or more external devices, and wherein the second set of one or more criteria is different from the first set of one or more criteria.

In some embodiments, a computer program product is described. In some embodiments, the computer program product comprises one or more programs configured to be executed by one or more processors of a computer system. In some embodiments, the one or more programs include instructions for: detecting an emergency condition; and in response to detecting the emergency condition: in accordance with a determination that the emergency condition satisfies a first set of one or more criteria, changing a state of a first set of one or more external devices; and in accordance with a determination that the emergency condition satisfies a second set of one or more criteria, changing a state of a second set of one or more external devices without changing the state of the first set of one or more external devices, wherein the second set of one or more external devices is different from the first set of one or more external devices, and wherein the second set of one or more criteria is different from the first set of one or more criteria.

In some embodiments, a method that is performed at a computer system that is in communication with one or more output devices and one or more display generation components is described. In some embodiments, the method comprises: while displaying, via the one or more display generation components, first content and second content and while outputting, via the one or more output devices, audio content corresponding to the second content, detecting activity within an area corresponding to the first content; and in response to detecting the activity within the area corresponding to the first content: in accordance with a determination that the activity satisfies a set of one or more criteria: ceasing output of, via the one or more output devices, the audio content corresponding to the second content; and outputting, via the one or more output devices, audio content corresponding to the first content; and in accordance with a determination that the activity does not satisfy the set of one or more criteria, maintaining output of, via the one or more output devices, the audio content corresponding to the second content.

In some embodiments, a non-transitory computer-readable storage medium storing one or more programs configured to be executed by one or more processors of a computer system that is in communication with one or more output devices and one or more display generation components is described. In some embodiments, the one or more programs includes instructions for: while displaying, via the one or more display generation components, first content and second content and while outputting, via the one or more output devices, audio content corresponding to the second content, detecting activity within an area corresponding to the first content; and in response to detecting the activity within the area corresponding to the first content: in accordance with a determination that the activity satisfies a set of one or more criteria: ceasing output of, via the one or more output devices, the audio content corresponding to the second content; and outputting, via the one or more output devices, audio content corresponding to the first content; and in accordance with a determination that the activity does not satisfy the set of one or more criteria, maintaining output of, via the one or more output devices, the audio content corresponding to the second content.

In some embodiments, a transitory computer-readable storage medium storing one or more programs configured to be executed by one or more processors of a computer system that is in communication with one or more output devices and one or more display generation components is described. In some embodiments, the one or more programs includes instructions for: while displaying, via the one or more display generation components, first content and second content and while outputting, via the one or more output devices, audio content corresponding to the second content, detecting activity within an area corresponding to the first content; and in response to detecting the activity within the area corresponding to the first content: in accordance with a determination that the activity satisfies a set of one or more criteria: ceasing output of, via the one or more output devices, the audio content corresponding to the second content; and outputting, via the one or more output devices, audio content corresponding to the first content; and in accordance with a determination that the activity does not satisfy the set of one or more criteria, maintaining output of, via the one or more output devices, the audio content corresponding to the second content.

In some embodiments, a computer system configured to communicate with one or more output devices and one or more display generation components is described. In some embodiments, the computer system comprises one or more processors and memory storing one or more programs configured to be executed by the one or more processors. In some embodiments, the one or more programs includes instructions for: while displaying, via the one or more display generation components, first content and second content and while outputting, via the one or more output devices, audio content corresponding to the second content, detecting activity within an area corresponding to the first content; and in response to detecting the activity within the area corresponding to the first content: in accordance with a determination that the activity satisfies a set of one or more criteria: ceasing output of, via the one or more output devices, the audio content corresponding to the second content; and outputting, via the one or more output devices, audio content corresponding to the first content; and in accordance with a determination that the activity does not satisfy the set of one or more criteria, maintaining output of, via the one or more output devices, the audio content corresponding to the second content.

In some embodiments, a computer system configured to communicate with one or more output devices and one or more display generation components is described. In some embodiments, the computer system comprises means for performing each of the following steps: while displaying, via the one or more display generation components, first content and second content and while outputting, via the one or more output devices, audio content corresponding to the second content, detecting activity within an area corresponding to the first content; and in response to detecting the activity within the area corresponding to the first content: in accordance with a determination that the activity satisfies a set of one or more criteria: ceasing output of, via the one or more output devices, the audio content corresponding to the second content; and outputting, via the one or more output devices, audio content corresponding to the first content; and in accordance with a determination that the activity does not satisfy the set of one or more criteria, maintaining output of, via the one or more output devices, the audio content corresponding to the second content.

In some embodiments, a computer program product is described. In some embodiments, the computer program product comprises one or more programs configured to be executed by one or more processors of a computer system that is in communication with one or more output devices and one or more display generation components. In some embodiments, the one or more programs include instructions for: while displaying, via the one or more display generation components, first content and second content and while outputting, via the one or more output devices, audio content corresponding to the second content, detecting activity within an area corresponding to the first content; and in response to detecting the activity within the area corresponding to the first content: in accordance with a determination that the activity satisfies a set of one or more criteria: ceasing output of, via the one or more output devices, the audio content corresponding to the second content; and outputting, via the one or more output devices, audio content corresponding to the first content; and in accordance with a determination that the activity does not satisfy the set of one or more criteria, maintaining output of, via the one or more output devices, the audio content corresponding to the second content.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIG. 3 is a block diagram of communications between different devices in accordance with some embodiments.

FIG. 4 illustrates a process for providing accessory information to a server through a background process in accordance with some embodiments.

FIG. 5 is a flow diagram illustrating a process for providing a portion of accessory information to a background process in accordance with some embodiments.

FIGS. 6A-6D illustrate a process for enabling services associated with a person based on the person being detected within an environment in accordance with some embodiments.

FIG. 7 is a flow diagram illustrating a process for enabling a service based on a detected subject in accordance with some embodiments.

FIGS. 8A-8F illustrate an ecosystem of connected devices within a home in accordance with some embodiments.

FIG. 9 is a flow diagram illustrating a process for altering a state of a set of external devices based on an emergency condition in accordance with some embodiments.

FIGS. 10A-10E illustrates exemplary user interfaces for outputting content based on detected activity in accordance with some embodiments.

FIG. 11 is a flow diagram illustrating a process for outputting audio based on activity within an area in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

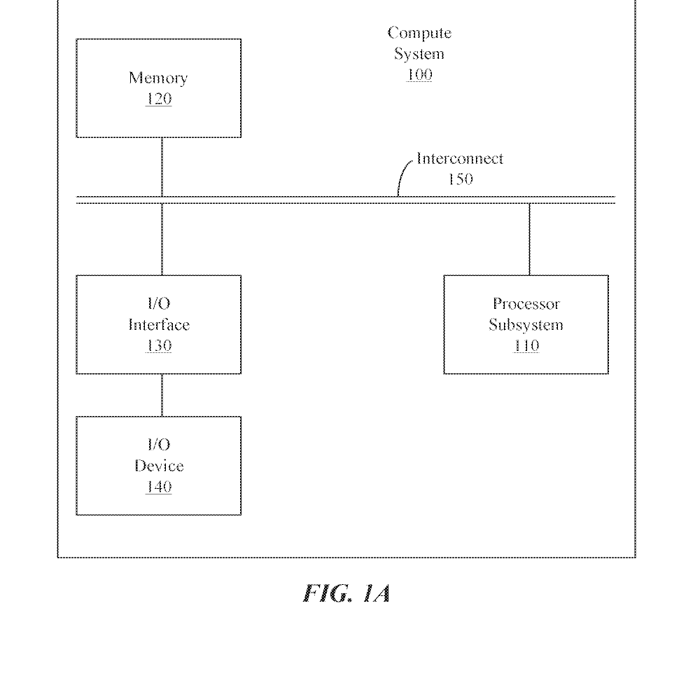

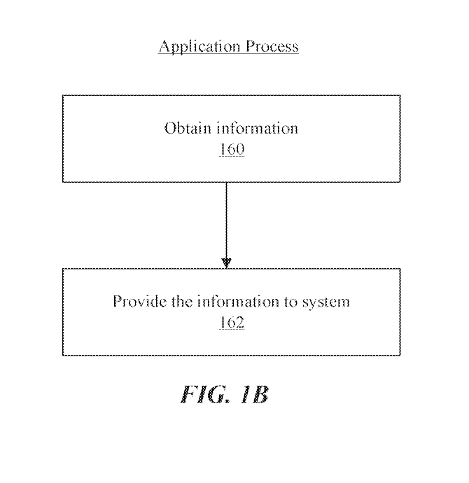

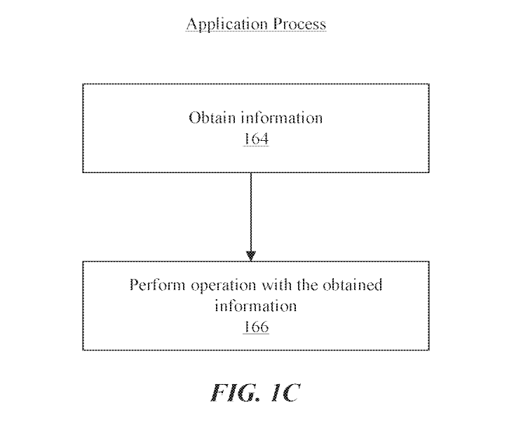

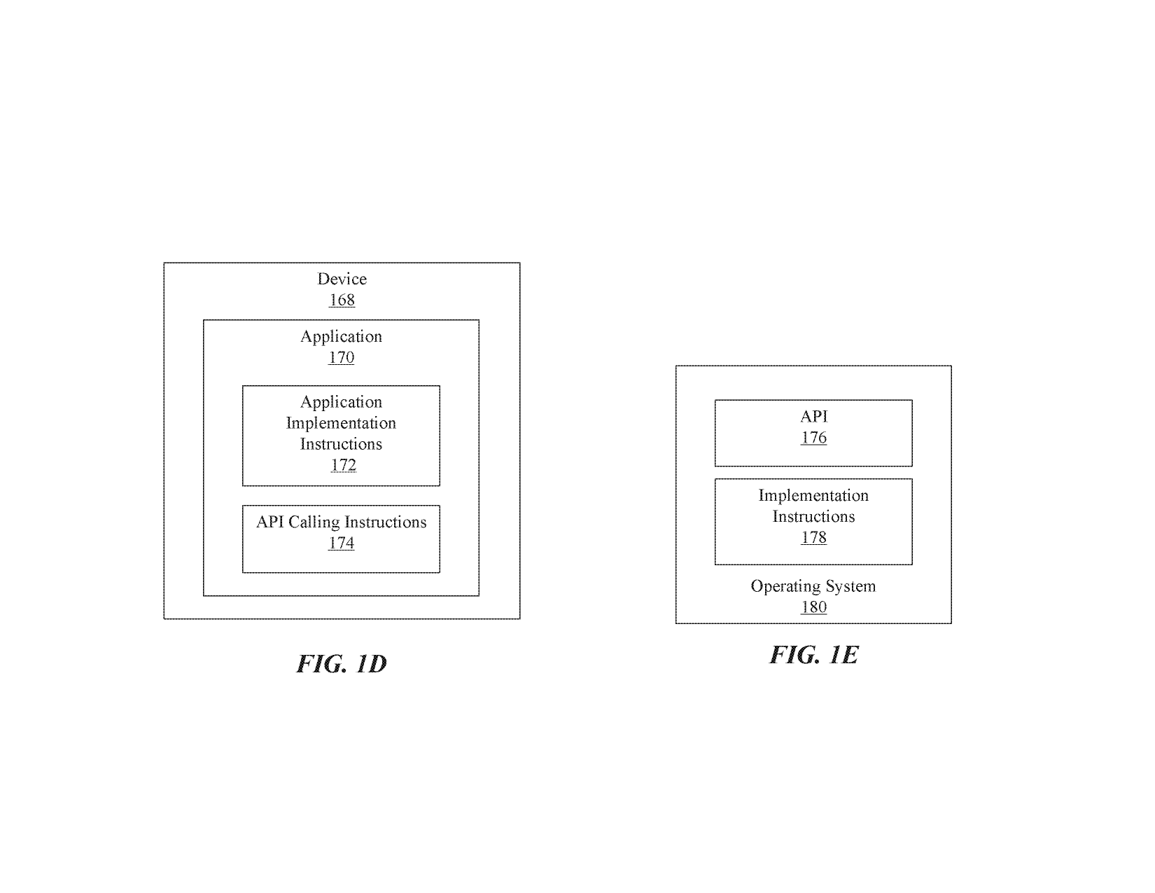

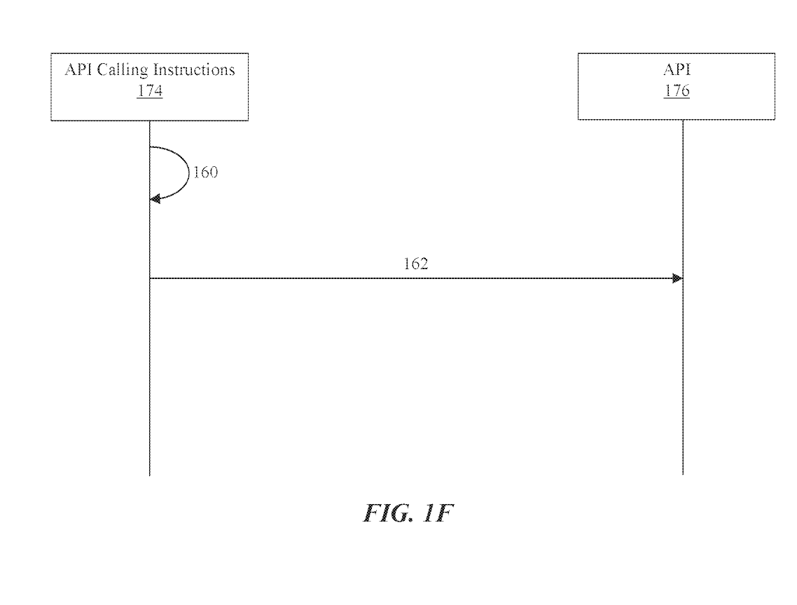

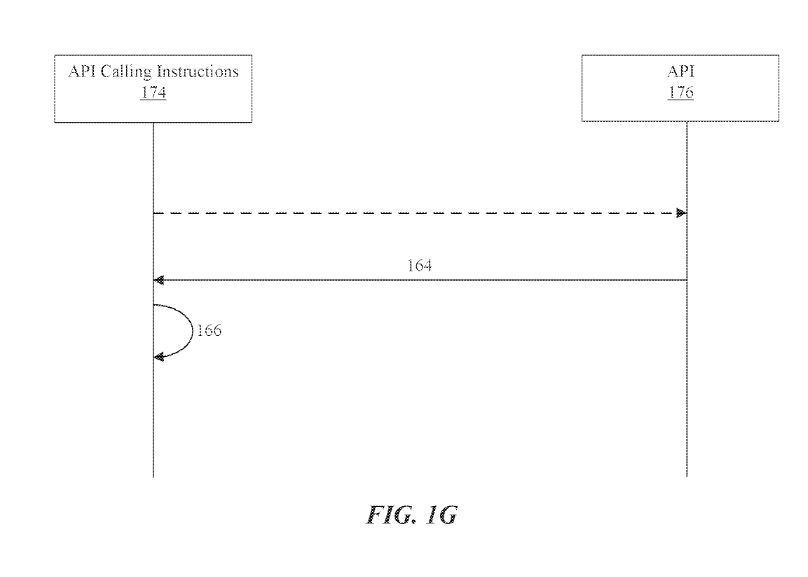

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

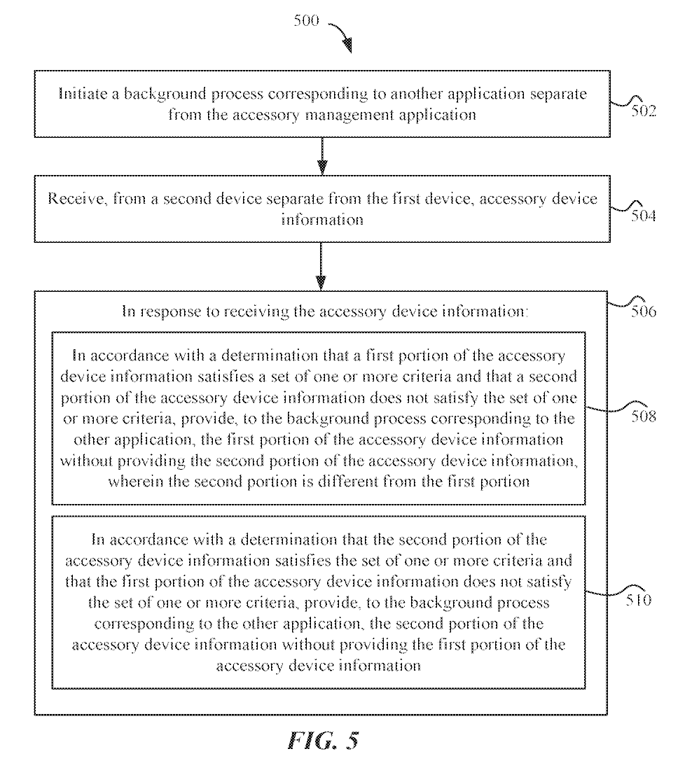

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 500, 700, 900, and 1100 (FIGS. 5, 7, 9, and 11) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIG. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

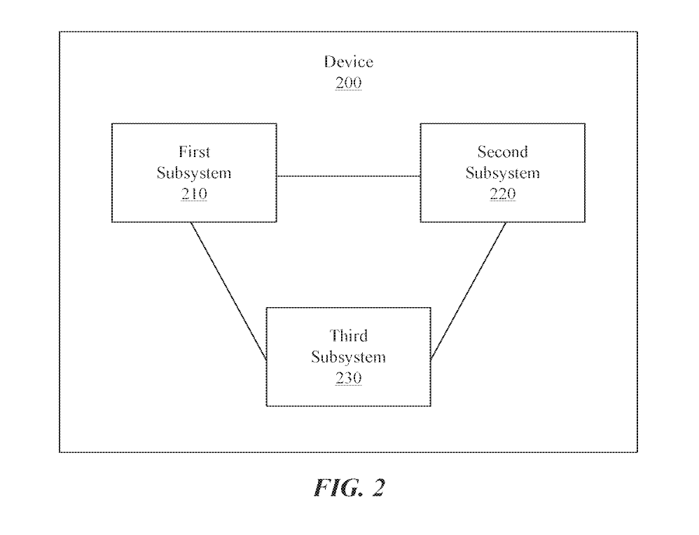

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for performing operations within an environment. Such techniques are described in the context of a personal device interacting with different accessory devices via a resident device and a server. It should be recognized that other types of electronic devices can be used with techniques described herein. For example, a smartphone can interact with another smartphone using techniques described herein. In addition, techniques optionally complement or replace other techniques for performing operations within an environment.

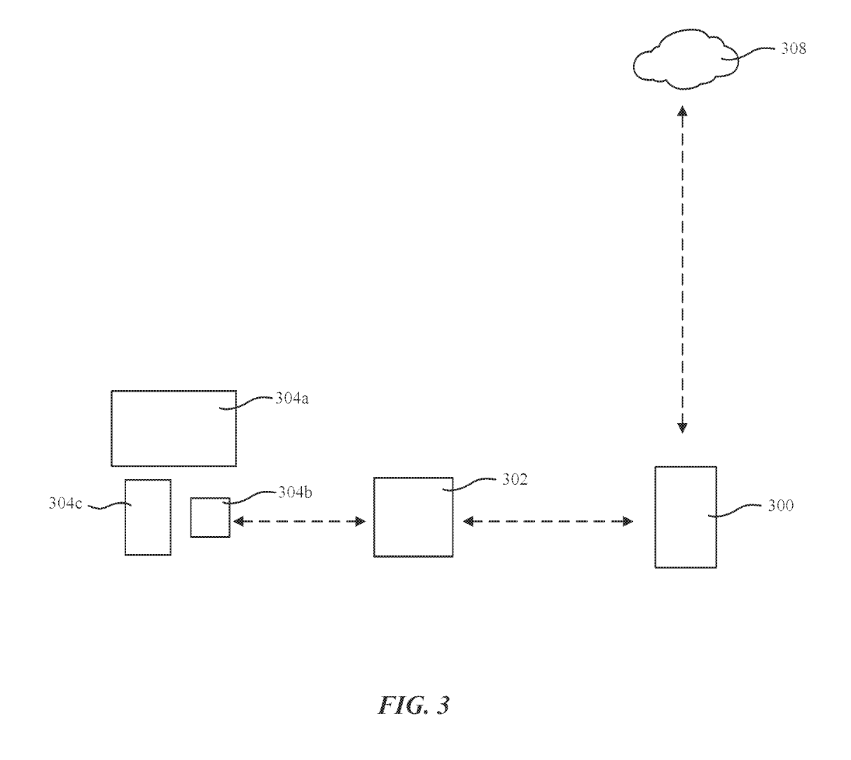

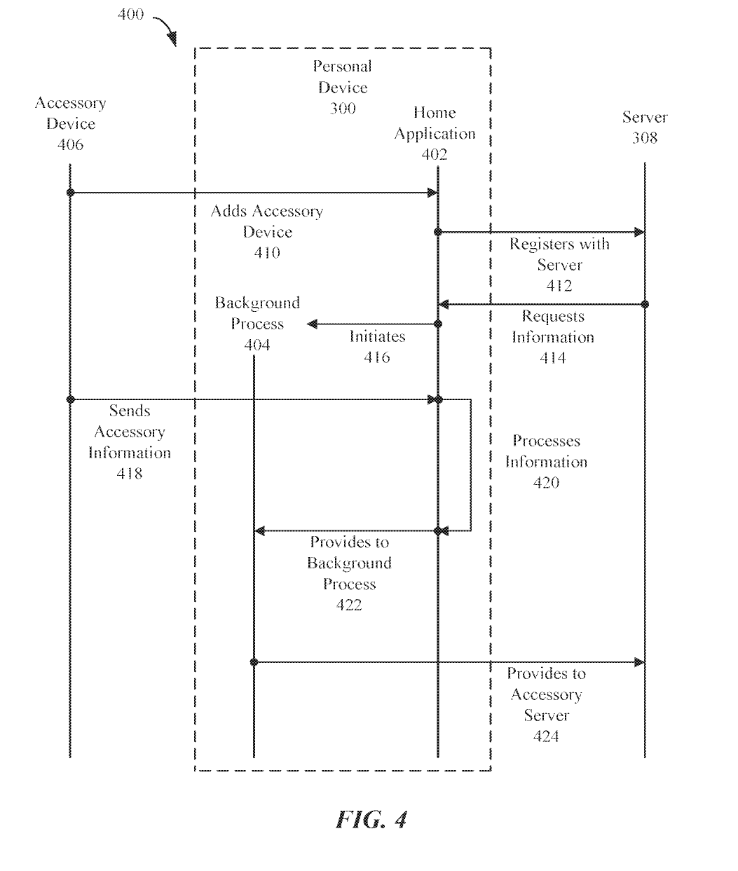

FIG. 3 is a block diagram of communications between different devices in accordance with some embodiments. The block diagram in this figure is used to illustrate the processes described below, including the processes in FIGS. 4-5.

As illustrated in FIG. 3, the different devices include different accessory devices (e.g., accessory 304a, accessory 304b, and accessory 304c), resident device 302, personal device 300, and server 308. While such devices are described in particular manners, it should be understood that the devices can be different types of devices and/or can include different functionality not discussed herein. For example, resident device 302 can be an accessory device that is configured to operate as a hub device for other accessory devices.

In some embodiments, the different accessory devices (e.g., accessory 304a, accessory 304b, and accessory 304c) are different accessory devices within an environment. Examples of such accessory devices include smart speakers, smart lights, smart plugs, smart locks, smart doorbells, smart thermostats, smart cameras, security systems, smart sensors, smart shades, smart blinds, smart fans, smart garage doors, and the like. In some embodiments, the different accessory devices are part of a network of devices, such as a wireless network (e.g., a Wi-Fi network) and/or a mesh network (e.g., a Thread network and/or peer network). In such embodiments, the different accessory devices can communicate with devices that are part of the network of devices. In some embodiments, the different accessory devices can also communicate with devices (e.g., personal device 300 and/or server 308) outside of the network of devices such as through resident device 300 as described further below. In some embodiments, different accessory devices are associated with different applications and/or different servers as described further below. For example, a light accessory device can be associated with (1) a light application that is provided by a manufacturer of the light accessory device and (2) a light server that is also provided by the manufacturer of the light accessory device. For another example, a fan accessory device can be associated with (1) a fan application that is provided by a manufacturer of the fan accessory device and (2) a fan server that is also provided by the manufacturer of the fan accessory device.

In some embodiments, resident device 302 is a device that is associated with the environment and part of the network of devices. For example, resident device 302 can be a communal device and/or a device affixed to a certain location within the environment (e.g., home, apartment, and/or office). In such embodiments, resident device 302 can enable communication with the different accessory devices, including communication with the different accessory devices by devices not part of the network of devices. For example, resident device 302 can receive a communication from personal device 300 for a particular accessory device and forward the communication to the particular accessory device.

In some embodiments, personal device 300 is a device that is associated with a user (e.g., a person associated with an active user profile). In such embodiments, personal device 300 can be able to communicate with the different accessory devices and/or resident device 302 due to a common user profile being shared across the devices (e.g., each device was paired by a common user and/or each device is registered to a common credential). In some embodiments, personal device 300 executes different applications, including the light application and the fan application described above and a management application. In such embodiments, the management application can manage an ecosystem of devices, including the different accessory devices and resident device 302. For example, a user of personal device 300 can initiate one or more actions to be performed by the different accessory devices through the management application (e.g., turn off lights, unlock doors, and/or control content output through connected speakers and/or displays). For another example, the user of personal device 300 can add, remove, and/or reassign accessory devices to the ecosystem of devices through the management application.

In some embodiments, server 308 is associated with a manufacturer of an accessory device of the different accessory devices. In such embodiments, server 308 can provide additional functionality to personal device 300 for the accessory device. In some embodiments, personal device 300 facilitates communication between the accessory device and server 308. For example, server 308 can request information about the accessory device through personal device 300, and personal device 300 can use the ecosystem of devices to gather such information to provide to server 308. In some embodiments, the network of devices also includes a hub device corresponding to the manufacturer of the accessory device. In such embodiments, the hub device can be separate from the accessory device and residence device 302. In some embodiments, the hub device can also facilitate communication between the accessory device and server 308, such communication outside of the ecosystem of devices.

FIG. 4 illustrates a process for providing accessory information to a server through a background process in accordance with some embodiments. The process in this figure is used to illustrate the processes described below, including the processes in FIG. 5.

As illustrated in FIG. 4, process 400 is performed by accessory device 406, personal device 300, and server 308. In some embodiments, accessory device 406 is an accessory device (e.g., accessory 304a, accessory 304b, and/or accessory device 304c) as discussed above with respect to FIG. 3. For example, accessory device 406 can be included in an ecosystem of devices with personal device 300 and resident device 302, enabling personal device 300 to manage accessory device 406 through resident device 302.

As illustrated in FIG. 4, personal device 300 executes home application 402. In some embodiments, home application 402 is a management application, allowing a user to perform one or more operations through the ecosystem of devices as discussed above with respect to FIG. 3. For example, home application 402 can obtain a state of a device within the ecosystem of devices and/or allow a user to change a state of one or more devices within the ecosystem of devices (e.g., turn on/off lights, unlock/lock doors, and/or open/close blinds), control activity performed by the one or more devices within the ecosystem of devices (e.g., playing content on a TV, playing music and/or audio content through speakers, and/or manipulating characteristics of content playback such as volume, locality, and/or playback assignments), and/or add or remove devices within the ecosystem of devices. In some embodiments, personal device 300 displays one or more controls and/or representations of accessory devices in a user interface of home application 402. For example, if accessory device 406 is a camera accessory device, personal device 300 can display a user interface of home application 402 including a live video feed, camera controls, and/or device information (e.g., current state, firmware version, update status, and/or error status) corresponding to accessory device 406.

As illustrated in FIG. 4, process 400 begins with home application 402 adding (410) accessory device 406 to the ecosystem of devices. In some embodiments, adding accessory device 406 to the ecosystem of devices includes completing one or more setup steps, such as assigning accessory device 406 an identifier, assigning accessory device 406 a location within an environment, assigning accessory device 406 to one or more automations, and/or adding accessory device 406 to a local network and/or a mesh network.

After adding accessory device 406 to the ecosystem of devices, home application 402 (414) registers accessory device 406 with server 308. In some embodiments, registering accessory device 406 with server 308 includes enabling one or more services associated with accessory device 406 and/or providing information about accessory device 406 to server 308. For example, home application 402 can provide server 308 a time and/or date for when accessory device 406 is activated along with model and/or skew of accessory device 406. It should be recognized that home application 402 might not register accessory device 406 with server 308 and that another application of personal device 300 can instead register accessory device 406 with server 308, such as an application associated with server 308 and accessory device 406 (e.g., the light application or the fan application described above with respect to FIG. 3).

After registering accessory device 406 with server 308, server 308 requests (414) information from home application 402. It should be recognized that the request can be made directly from server 308 and/or via the application associated with server 308. In some embodiments, the request is for device information about accessory device 406 so that server 308 can act upon such information. In some embodiments, process 400 is ended at 414 in response to home application 402 determining that server 308 requests unauthorized information. For example, home application 402 can terminate process 400 in response to server 308 requesting personal information of a user and/or information that violates one or more criteria set by home application 402, as discussed below.

In some embodiments, after receiving server 308’s request for information, home application 402 (416) initiates background process 404. In some embodiments, background process 404 is associated with and/or provided by the application associated with server 308. In such embodiments, background process 404 can execute separate from the application associated with server 308 so as not to require the application associated with server 308 to be executing when background process 404 is executing. In some embodiments, background process 404 provides and/or facilitates through server 308 one or more services accessible through the application associated with server 308, such as device updates and/or service requests. In such embodiments, background process 404 can be a limited process that provides less functionality than the application associated with server 308.

In some embodiments, after initiating background process 404, home application 402 provides background process 404 general information (e.g., a device identifier, a network identifier, and/or an application token) about accessory device 406 and/or server 308. For example, home application 402 can provide background process 404 a unique identifier associated with accessory device 406 to enable background process 404 to verify accessory information provided by home application 402, as discussed below. For another example, home application 402 can provide background process 404 a communication identifier for server 308 (e.g., network address, communication channel, and/or token for authenticating with server 308) to enable background process 404 to communicate with server 308, as discussed below. In some embodiments, after background process 404 is initiated, personal device 300 enables a connection between background process 404 and server 308. For example, personal device 300 can provide background process 404 a secure communication channel (e.g., an encrypted data channel and/or encrypted data tunnel) to provide information to server 408 as discussed further below.

After adding accessory device 406 to the ecosystem of devices, accessory device 406 sends (418) accessory information to home application 402. In some embodiments, the accessory information includes device information and/or information obtained from one or more sensors of accessory device 406. For example, the accessory information can include device status information such as battery level, connectivity status, firmware version, and/or an error log. For another example, the accessory information can include detected information such as motion detection, security event information, and/or other sensor readings. In some embodiments, the accessory information is sent to home application 402 through resident device 302 as described above with respect to FIG. 3. In some embodiments, background process 404 is initiated in response to home application 402 receiving the accessory information. In other embodiments, background process 404 is initiated before home application 402 receives the accessory information.

After receiving the accessory information, home application 402 processes (420) the accessory information. In some embodiments, processing the accessory information includes identifying information to send to background process 404 and/or removing information that should not be sent to background process 404. For example, home application 402 can remove information based on one or more user preferences. For another example, home application 402 can remove information based on a privacy policy, such as an application privacy policy and/or device-based privacy policy (e.g., that applies to all applications and/or processes on personal device 300).

In some embodiments, process 400 ends when home application 402 processes the accessory information. For example, while processing the accessory information, home application 402 can determine that none of the accessory information should be sent to background process 404 and, in response, terminates process 400 and/or background process 404. In some embodiments, in response to determining that none of the accessory information should be sent to background process 404, home application 402 deletes the accessory information.

In some embodiments, in response to determining that some of the accessory information should not be sent to background process 404, home application 402 attempts to remove such accessory information in order to provide background process 404 conforming accessory information. For example, while processing the accessory information, home application 402 can remove nonconforming information by deleting and/or overwriting a portion of the accessory information (and/or not sending the nonconforming information). In some embodiments, background process 404 is unaware of the nonconforming information. For example, home application 402 can provide conforming accessory information without informing background process 404 and/or server 308 of nonconforming information. In some embodiments, home application 402 informs background process 404 of the existence of nonconforming accessory information. For example, home application 402 uses process 400 to inform server 308, through background process 404, of an information policy preventing transmission of nonconforming accessory information.

After processing the accessory information, home application 402 provides (422) the accessory information (and/or a portion of the accessory information) to background process 404. In some embodiments, home application 402 deletes accessory information that is not provided to background process 404, as discussed above.

In some embodiments, home application 402 initiates more than one background process. For example, home application 402 can initiate a background process for each application (e.g., and associated server) that home application 402 seeks to provide accessory information. In some embodiments, each background process can be configured with different limitations. For example, home application 402 can determine that different applications have different trust profiles (e.g., a first-party application can have a higher trust with home application 402 than a third-party application) and allow different background processes to transmit different information (e.g., removing personal information from information transmitted to the application with a lower trust profile). In some embodiments, home application 402 provides the accessory information or different portions of the accessory information to different background processes (e.g., including or not including background process 404). For example, different background processes can request the same accessory information or different accessory information and home application 402 can provide such information to such background processes as home application 402 receives accessory information from accessory devices.

After receiving the accessory information from home application 402, background process 404 provides (424) the accessory information to server 308. In some embodiments, background process 404 provides the accessory information to server 308 through a secure communication channel. For example, personal device 300 can establish a secure tunnel and/or connection with server 308 before background process 404 provides the accessory information.

In some embodiments, after providing the accessory information to server 308, home application 402, the application associated with server 308, and/or accessory device 406 can receive a communication corresponding to accessory device 406 from server 308. For example, home application 402, the application associated with server 308, and/or accessory device 406 can receive an indication of a need to reset accessory device 406, an indication to perform a firmware update on accessory device 406, and/or a request for accessory device 406 to perform one or more operations (e.g., provide other accessory information to server 308) from server 308. In such embodiments, the communication can be sent by server 308 as a response based on the accessory information provided to server 308 by background process 404. For example, the accessory information can indicate that accessory device 406 is not operating properly and server 308 can cause accessory device 406 to be reset.

FIG. 5 is a flow diagram illustrating a process (e.g., process 500) for providing a portion of accessory information to a background process in accordance with some embodiments. Some operations in process 500 are, optionally, combined, the orders of some operations are, optionally, changed, and some operations are, optionally, omitted.

As described below, process 500 provides an intuitive way for providing a portion of accessory information to a background process. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a first device (e.g., 300) (e.g., a watch, a phone, a tablet, a fitness tracking device, a processor, a head-mounted display (HMD) device, a communal device, an accessory device, a media device, a speaker, a television, an electronic device, and/or a personal computing device), by an accessory management application (e.g., as discussed above with respect to FIG. 3 and/or 402 in FIG. 4). In some embodiments, the accessory management application is an application used to add, remove, and/or manipulate accessory devices within a network of accessory devices (e.g., a home network and/or mesh network of accessory devices). In some embodiments, the accessory management application corresponds to an accessory ecosystem and/or a physical location. In some embodiments, the accessory management application is and/or includes a background process. In some embodiments, the accessory management application is and/or includes a foreground process.

The accessory management application initiates (502) a background process (e.g., 404) corresponding to (e.g., provided by, of, belonging to, managed by, and/or that is part of) another application (e.g., as discussed above with respect to FIG. 3 and/or FIG. 4) separate (and/or different) from the accessory management application. In some embodiments, the background process is a simplified, device managed, process that has limited access and/or rights. In some embodiments, the background process is managed by the other application. In some embodiments, the background process has a limited set of functionalities derived from the other application and/or the accessory management application. In some embodiments, the other application corresponds to one or more accessory devices. In some embodiments, the accessory management application corresponds to the one or more accessory devices and one or more other accessory devices that do not correspond to the other application.

The accessory management application receives (504) (e.g., before or after initiating the background process), from a second device (e.g., 304a-c and 406) (e.g., a watch, a phone, a tablet, a fitness tracking device, a processor, a head-mounted display (HMD) device, a communal device, an accessory device, a media device, a speaker, a television, an electronic device, and/or a personal computing device) separate (and/or different) from the first device, first accessory device information (e.g., as discussed above with respect to FIG. 3 and/or FIG. 4) (e.g., raw accessory information and/or unmodified accessory information). In some embodiments, the first accessory device information is received through a network of devices and/or a communication channel (e.g., Wi-Fi and/or Thread). In some embodiments, the first accessory device information includes status information (e.g., network status, device status, and/or error status), information corresponding to an environment (e.g., time, date, and/or detected contexts such as subjects, emergencies, and/or activity), and/or sensor readings from one or more accessory devices. In some embodiments, the first accessory device information corresponds to an accessory device different and/or separate from the first device. In some embodiments, the accessory device is the second device. In some embodiments, the accessory device is different and/or separate from the second device.

In response to (506) receiving the first accessory device information, in accordance with a determination that a first portion (e.g., as discussed above with respect to 420 in FIG. 4) (e.g., a status, a setting, and/or a value) of the first accessory device information satisfies a set of one or more criteria (e.g., as discussed above with respect to 420 in FIG. 4) and that a second portion (e.g., as discussed above with respect to 420 in FIG. 4) (e.g., a status, a setting, and/or a value) of the first accessory device information does not satisfy the set of one or more criteria (e.g., as discussed above with respect to 420 in FIG. 4), the accessory management application provides (508) (e.g., 422) (e.g., sends, transmits, stores, and/or makes available via a memory location), to the background process corresponding to the other application, the first portion of the first accessory device information without providing, to the background process corresponding to the other application, the second portion of the first accessory device information, wherein the second portion is different from the first portion. In some embodiments, the set of one or more criteria is at least partially defined by the accessory management application. In some embodiments, the set of one or more criteria is at least partially defined by the other application. In some embodiments, the set of one or more criteria includes a criterion that is satisfied when a portion of accessory device information corresponds to a particular device (e.g., a portion (e.g., the first portion and/or the second portion) of accessory device information satisfies the set of one or more criteria when the portion corresponds to a particular device). In some embodiments, the set of one or more criteria includes a criterion that is satisfied when a portion of accessory device information is a particular type of accessory device information (e.g., a portion (e.g., the first portion and/or the second portion) of accessory device information satisfies the set of one or more criteria when the portion is a particular type of accessory device information). In some embodiments, the set of one or more criteria includes a criterion that is satisfied when a portion of accessory device information is determined to correspond to information requested by the other application (e.g., a portion (e.g., the first portion and/or the second portion) of accessory device information satisfies the set of one or more criteria when the portion is determined to correspond to information requested by the other application).

In response to (506) receiving the first accessory device information, in accordance with a determination that the second portion of the first accessory device information satisfies the set of one or more criteria (e.g., as discussed above with respect to 420 in FIG. 4) and that the first portion of the first accessory device information does not satisfy the set of one or more criteria (e.g., as discussed above with respect to 420 in FIG. 4), the accessory management application provides (510) (e.g., 422), to the background process corresponding to the other application, the second portion of the first accessory device information without providing, to the background process corresponding to the other application, the first portion of the first accessory device information. In some embodiments, the accessory management application processes and/or modifies the first accessory device information before providing the first portion and/or the second portion to the background process corresponding to the other application. In some embodiments, after receiving the first accessory device information, the accessory management application controls an amount and/or what part of the first accessory device information is provided to the background process corresponding to the other application. In some embodiments, the set of one or more criteria includes a set of constraints and/or limitations on accessory device information that can be provided to the background process corresponding to the other application (e.g., the accessory management application prevents private information and/or sensitive information from being provided to the other application). In some embodiments, in response to receiving the first accessory device information, the accessory management application discards accessory device information that does not satisfy the set of one or more criteria. In some embodiments, in response to receiving the first accessory device information and in accordance with a determination that the first portion of the first accessory device information satisfies the set of one or more criteria and that the second portion of the first accessory device information satisfies the set of one or more criteria, the accessory management application provides, to the background process corresponding to the other application, the first portion of the first accessory device information and the second portion of the first accessory device information. In some embodiments, in response to receiving the first accessory device information and in accordance with a determination that the first portion of the first accessory device information does not satisfy the set of one or more criteria and that the second portion of the first accessory device information does not satisfy the set of one or more criteria, the accessory management application forgoes provision of, to the background process corresponding to the other application, a portion (e.g., the first portion, the second portion, and/or another portion different from the first portion and the second portion) of the first accessory device information.

In some embodiments, the set of one or more criteria includes a criterion that is satisfied when a portion of accessory device information (e.g., as discussed above with respect to 418 in FIG. 4) is less than a threshold amount of data (e.g., as discussed above with respect to 420 in FIG. 4). In some embodiments, the threshold amount of data corresponds to a size limit (e.g., a maximum size that can be provided to the background process and/or a maximum amount of data that can be provided at once) and/or a bandwidth limit (e.g., a maximum amount of data that can be provided over time and/or a maximum rate at which accessory information can be provided to the background process). In some embodiments, the first device processes the first accessory device information by removing information over the threshold amount of data (e.g., the first device removes certain types of data and/or removes all data after the threshold amount of data is reached).

In some embodiments, the set of one or more criteria is a first set of one or more criteria. In some embodiments, in response to receiving the accessory device information and in accordance with a determination that the first portion of the first accessory device information satisfies a second set of one or more criteria, wherein the second set of one or more criteria includes a criterion that is satisfied when a portion of accessory device information is greater than the threshold amount of data (e.g., as discussed above with respect to 420 in FIG. 4), the accessory management application terminates the background process corresponding to the other application (e.g., as discussed above with respect to FIG. 4). In some embodiments, while (and/or after) terminating the background process corresponding to the other application, the computer system deletes the accessory device information. In some embodiments, the first device terminates the background process by deleting the background process, deleting any information associated with the background process, and/or ending any communication corresponding to the background process. In some embodiments, the second set of one or more criteria is at least partially defined by the accessory management application. In some embodiments, the second set of one or more criteria is at least partially defined by the other application. In some embodiments, the second set of one or more criteria includes a criterion that is satisfied when a portion of accessory device information corresponds to a particular device. In some embodiments, the second set of one or more criteria includes a criterion that is satisfied when a portion of accessory device information is a particular type of accessory device information. In some embodiments, the second set of one or more criteria includes a criterion that is satisfied when a portion of accessory device information is determined to correspond to information requested by the other application.

In some embodiments, the set of one or more criteria includes a criterion that is satisfied when a portion of accessory device information aligns with one or more preferences (e.g., as discussed above with respect to 420 in FIG. 4) corresponding to (e.g., set by, associated with, and/or defined for) a user (e.g., as discussed above with respect to FIG. 3 and/or 420 in FIG. 4) (e.g., a user of the first device, a user of the accessory management application, and/or a profile active on the accessory management application and/or the first device). In some embodiments, the one or more preferences corresponding to the user can include what information can be provided to the background process and/or transmitted to other devices, privacy considerations (e.g., anonymizing information and/or removing certain portions of information associated with a user), and/or device settings (e.g., one or more setting provided by the first device and/or the accessory management application).

In some embodiments, the set of one or more criteria includes a criterion that is satisfied when a portion of accessory device information aligns with one or more limitations (e.g., as discussed above with respect to 420 in FIG. 4) defined by the accessory management application. In some embodiments, the one or more limitations defined by the accessory management application are limitations on information (e.g., pieces of information not allowed to be within accessory device information and/or types of information that should be excluded from accessory device information sent to the background process). In some embodiments, the one or more limitations defined by the accessory management application allow the first device to prevent private and/or sensitive information from being provided to the background process. In some embodiments, the one or more limitations defined by the accessory management application correspond to a privacy policy (e.g., guidelines and/or settings that prevent personal information and/or certain types of user information from being provided to third-party services and/or computer systems).

In some embodiments, the set of one or more criteria includes a criterion that is satisfied when a portion of accessory device information aligns with one or more limitations (e.g., as discussed above with respect to 420 in FIG. 4) provided to the accessory management application by an operating system (e.g., as discussed above with respect to 420 in FIG. 4) of the first device. In some embodiments, the one or more limitations provided to the accessory management application are provided to one or more other applications on the first device (e.g., the one or more limitations are information limitations that are provided to all applications on the first device and/or the one or more limitations are device wide limitations on information enforced by the first device). In some embodiments, the operating system initiates and/or manages the background process (and/or other background processes). In some embodiments, the operating system manages and/or provides information transmission for and/or on behalf of the accessory management application. In some embodiments, the operating system enforces restrictions on the background process (e.g., limitation on information and/or limitation on transmission to other devices).

In some embodiments, the set of one or more criteria includes a criterion that is satisfied when the background process (and/or the other application) has an entitlement (e.g., as discussed above with respect to 420 in FIG. 4) to receive a portion of accessory device information. In some embodiments, the entitlement includes access to one or more hardware functions (e.g., the entitlement allows the background process to communicate through a wireless network component and/or access to a read and/or write to a storage location), one or more services (e.g., the entitlement allows the background process to use other processes and/or communicate with one or more third-party services), and/or one or more data provisions (e.g., the entitlement allows the background process to receive information of a certain type and/or information that aligns with a certain privacy level).

In some embodiments, the entitlement is provided to (e.g., defined by, assigned to, and/or declared for) the background process by the accessory management application (e.g., as discussed above with respect to 420 in FIG. 4). In some embodiments, the entitlement provides the background process one or more features from the accessory management application (e.g., the background process inherits access and/or right to one or more features from the accessory management application). In some embodiments, the background process shares the one or more features with the accessory management application (e.g., access to a common storage location and/or access to a common communication channel). In some embodiments, the entitlement allows the background process to communicate with the accessory management application (e.g., the first device allows the accessory management application to provide the background process information due to the entitlement and/or the first device trusts activity performed by the background process due to its association with the accessory management application through the entitlement).

In some embodiments, the entitlement is provided to (e.g., defined by, assigned to, and/or declared for) the background process by the other application (e.g., as discussed above with respect to 420 in FIG. 4). In some embodiments, the entitlement provides the background process one or more features from the other application (e.g., the background process inherits access and/or rights to one or more features from the other application). In some embodiments, the background process gains and/or is provided the one or more features from the other application (e.g., access to a common storage location and/or access to a common communication channel). In some embodiments, the entitlement allows the background process to communicate outside of the first device based on its association with the other application (e.g., the first device allows the background process to provide information outside of the first device due to the entitlement and/or the first device trusts activity performed by the background process due to its association with the other application through the entitlement).

In some embodiments, the set of one or more criteria includes a criterion that is satisfied when a portion of accessory device information is included at a particular location (e.g., as discussed above with respect to 422 in FIG. 4) (e.g., a field, a variable, a set of bits and/or bytes, and/or pointed to by a pointer) within the accessory device information. In some embodiments, the particular location is identified using protocol information, header information, information about the accessory information such as metadata, and/or one or more information fields that are always provided irrespective of which portion of accessory device information.

In some embodiments, the first accessory device information is received from the second device through a secure communication channel (e.g., as discussed above with respect to 418 in FIG. 4) with the second device. In some embodiments, the secure communication channel is a communication channel that requires a level of encryption, authentication to connect to and/or communicate through, and/or one or more steps for establishing (e.g., an unsecure handoff of setup information and/or initial authentication communication before sending the first accessory device information).

In some embodiments, after receiving the first accessory device information and before providing the first portion of the first accessory device information to the background process, the accessory management application processes (e.g., as discussed above with respect to 420 in FIG. 4), via the accessory management application, the first accessory device information, wherein processing the first accessory device information includes removing (e.g., as discussed above with respect to 420 in FIG. 4) a portion of the first portion of the first accessory device information, wherein the first portion of the first accessory device information provided to the background process is after the first portion of the first accessory device is processed by the accessory management application (e.g., the portion of the first portion of the first accessory device information is not provided to the background process). In some embodiments, processing the first accessory device information includes separating the first portion of the first accessory device information from the second portion of the first accessory device information based on the set of one or more criteria. In some embodiments, processing the first accessory device information includes anonymizing the first accessory device information (e.g., removing identifying information and/or information connecting to a user), reformatting information (e.g., encrypting, formatting to a certain communication protocol, and/or formatting for the background process), and/or compiling information (e.g., combining a portion of the first accessory device information with other information to minimize communication and/or including additional information from the accessory management application and/or the first device).

In some embodiments, the background process has a reduced set of capabilities as compared to the other application (e.g., as discussed above with respect to 404 and/or 416 in FIG. 4) (e.g., the background process is a limited process, such as a supervised process and/or process with one or more predefined capabilities). In some embodiments, the limited process is dependent on another process and/or application (e.g., an application, such as the accessory management application, provides one or more functions to the limited process and/or an application, such as the accessory management application, governs communication with the limited process such as restricting the type of information and/or restricting where the information can be transmitted). In some embodiments, the limited process is not a full application (e.g., the limited process has a reduced set of capabilities as compared to an application such as the accessory management application and/or the other application).

In some embodiments, before initiating the background process corresponding to the other application, the accessory management application adds (e.g., pairs, assigns, and/or registers) the second device to the accessory management application (e.g., as discussed above with respect to FIG. 3 and/or 410 in FIG. 4), wherein the background process corresponding to the other application is initiated in response to adding the second device to the accessory management application. In some embodiments, the background process is initiated once per application and device (e.g., the background process corresponds to the other application and the second application and/or additional background processes are initiated for additional applications and/or devices).

In some embodiments, a service (e.g., 308 in FIG. 3 and/or FIG. 4) (e.g., corresponding to the other application and/or through the other application, such as a feature provided by the other application and/or another device (e.g., a server) corresponding to the other application) corresponding to the other application is enabled (e.g., as discussed above with respect to FIG. 3) before initiating the background process. In some embodiments, the background process is initiated in response to the accessory management application detecting that the service is enabled. In some embodiments, the service is provided by another computer system and/or a server. In some embodiments, enabling the service includes connecting, via a communication channel, to the service. In some embodiments, the communication channel is a network connection and/or secure communication channel established between the first device and another device (e.g., a third-party device and/or server). In some embodiments, the service is enabled via the accessory management application. In some embodiments, the service is enabled via the other application. In some embodiments, the service corresponds to maintenance and/or support for an accessory device corresponding to the other application. In some embodiments, when the first portion of the first accessory device is provided to the background process, the first portion corresponds to (e.g., pertains to, is about, and/or is associated with) the accessory device corresponding to the other application.

In some embodiments, the background process is initiated in response to receiving the first accessory device information from the second device (e.g., 418). In some embodiments, the accessory management application initiates the background process once per application (e.g., the same background process is used for the other application each time the accessory management application receives accessory device information). In some embodiments, the background process is initialized each time the accessory management application receives accessory device information (e.g., the accessory management application terminates and/or reinitializes the background process for increased security and/or information management).

In some embodiments, after providing, to the background process corresponding to the other application, the first portion of the accessory device information without providing, to the background process corresponding to the other application, the second portion of the accessory device information, the accessory management application receives, from a third device (e.g., 308) (and/or a server corresponding to the other application and/or associated with the other application), a response (e.g., as discussed above with respect to 424 in FIG. 4) corresponding to the first portion of the first accessory device information, wherein the third device is different from the first device (and/or the second device). In some embodiments, after providing the first portion of the accessory device information without providing the second portion of the accessory device information and before receiving the response corresponding to the first portion of the accessory deice information, the first device transmits, via the background process, the first portion of the accessory device information to the third device without transmitting, via the background process, the second portion of the accessory device to the third device. In some embodiments, after receiving the response corresponding to the first portion of the accessory device information, the accessory management application performs, via the accessory management application, one or more operations based on the response (e.g., as discussed above with respect to 424 in FIG. 4). In some embodiments, performing the one or more operations include outputting, via one or more output devices (e.g., a display generation component, an audio generation component, and/or a haptic generation component) of the first device, an indication of the response (e.g., displaying a service notification and/or outputting a device status message). In some embodiments, the display generation component includes a display screen, a projector, a head mounted display, and/or a touch-sensitive display. In some embodiments, the audio generation component includes a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, performing the one or more operations include changing a state of the second device (e.g., resetting the second device, updating the second device, and/or changing a parameter of the second device).

In some embodiments, the second device is a resident device (e.g., 302). In some embodiments, the resident device is a device located within a certain location of an environment and/or affixed to a location within an environment (e.g., a device situated on a countertop of a kitchen and/or mounted to a wall of a room within a home). In some embodiments, the resident device is a device that is associated with a home (e.g., multiple users can use the resident device while within the home and/or within a certain proximity of the resident device). In some embodiments, the resident device is a home management device (e.g., the resident device manages connected devices and/or accessory devices directly and/or through the accessory management application). In some embodiments, the resident device is in communication with one or more accessory devices (e.g., an accessory device corresponding to the first accessory device information). In some embodiments, the first device is not in communication with the one or more accessory devices.

In some embodiments, the second device is an accessory device (e.g., 304a-c and/or 406). In some embodiments, the accessory device is a device that needs another device and/or application to enable functionality (e.g., a camera accessory device is capable of local recordings and the accessory management application can enable remote access, remote recording, and/or monitoring to the camera accessory device). In some embodiments, the accessory device is a network connected device and/or device with capability of interacting with an object and/or the physical environment (e.g., a lock accessory device, a network management device, and/or blind accessory device).

In some embodiments, the first device is a communal device (e.g., 300 and/or 302). In some embodiments, the communal device is a device that is situated within a location of an environment (e.g., placed on a countertop of a kitchen within a home and/or affixed to a community space within an apartment), enabling usage by more than one user (e.g., the communal device provides functionality to subjects within the environment, the communal device is not associate with a profile for a subject but obtains one or more profiles from other devices associated with one or more subjects, and/or the communal device provides functionality to recognized subjects within the environment without requiring the subject to login), and/or the communal device is associated with an ecosystem of devices (e.g., the communal device is linked with a home and allows more than one user to manage and/or make changes to the home and/or the communal device provides connections to one or more other devices and allows more than one device to connect to it and/or through it to connect to the one or more other devices such as acting as a hub device for communication with the home and/or the one or more other devices).

In some embodiments, the first device is a personal device (e.g., 300). In some embodiments, the personal device is associated with a user (e.g., a user is logged in on the personal device and/or a profile of the user is currently active on the device). In some embodiments, the profile of the user includes device settings (e.g., personalized user interfaces and/or user preferences of the device), content (e.g., information corresponding to the user and/or information gathered and/or received while the profile of the user is active), and/or a set of services corresponding to the user (e.g., third-party services and/or connections that are associated with a credential and/or identifier of the user). In some embodiments, the personal device is a device that is physically associated with a user (e.g., a wearable device and/or a smart phone device). In some embodiments, the personal device can connect to the second device and/or accessory devices directly and/or through a network of devices (e.g., through a communal device and/or home network).

In some embodiments, in response to receiving the accessory device information and in accordance with a determination that a (e.g., any) portion of the first accessory device information does not satisfy the set of one or more criteria (e.g., as discussed above with respect to 420 in FIG. 4) (and/or that no portion of the first accessory device information satisfies the set of one or more criteria), the accessory management application forgoes providing, to the background process corresponding to the other application, a (e.g., any) portion of the first accessory device information (e.g., as discussed above with respect to 420 in FIG. 4). In some embodiments, after not providing a portion of the first accessory device information to the background process, the first device deletes and/or processes (e.g., attempts to make a portion of the first accessory device information satisfy the set of one or more criteria and/or removes a portion of the first accessory device information that does not satisfy the set of one or more criteria) the first accessory device information and/or a portion of the first accessory device information.

In some embodiments, the set of one or more criteria is a first set of one or more criteria. In some embodiments, the other application is a first application. In some embodiments, the background process is a first background process (e.g., as discussed above with respect to 422 in FIG. 4). In some embodiments, the accessory management application initiates a second background process corresponding to a second application separate (and/or different) from the accessory management application and the first application, wherein the second background process is separate (and/or different) from the first background process. In some embodiments, the second background process is a simplified, device managed, process that has limited access and/or rights. In some embodiments, the second background process is managed by the second application. In some embodiments, the background process has a limited set of functionalities derived from the second application and/or the accessory management application. In some embodiments, the second application is another application associated with the second device (e.g., provides additional functionality to the second device). In some embodiments, the second application is associated with one or more accessory devices including the second device (e.g., another ecosystem of device is separate from the accessory management application and/or an ecosystem of device compatible with the accessory management application). In some embodiments, after initiating the second background process, in response to receiving the first accessory device information, and in accordance with a determination that the first portion of the first accessory device information satisfies a third set of one or more criteria (e.g., as discussed above with respect to 422 in FIG. 4), the accessory management application provides, to the second background process, the first portion of the first accessory device information (e.g., as discussed above with respect to 422 in FIG. 4) (e.g., with or without providing, to the first background process, the first portion of the first accessory device information), wherein the third set of one or more criteria is different from the first set of one or more criteria. In some embodiments, the third set of one or more criteria is at least partially defined by the second application. In some embodiments, the third set of one or more criteria is at least partially defined by the accessory management application (e.g., configured for the second application and/or to enable operability with the second application). In some embodiments, the third set of one or more criteria includes a criterion based on the first accessory device information (e.g., type, size, content, and/or privacy level). In some embodiments, the third set of one or more criteria includes a criterion that is satisfied when a portion of accessory device information corresponds to a particular device (e.g., a portion (e.g., the first portion and/or the second portion) of accessory device information satisfies the third set of one or more criteria when the portion corresponds to a particular device). In some embodiments, the third set of one or more criteria includes a criterion that is satisfied when a portion of accessory device information is a particular type of accessory device information (e.g., a portion (e.g., the first portion and/or the second portion) of accessory device information satisfies the third set of one or more criteria when the portion is a particular type of accessory device information). In some embodiments, the third set of one or more criteria includes a criterion that is satisfied when a portion of accessory device information is determined to correspond to information requested by the second application (e.g., a portion (e.g., the first portion and/or the second portion) of accessory device information satisfies the third set of one or more criteria when the portion is determined to correspond to information requested by the second application).

In some embodiments, the set of one or more criteria is a first set of one or more criteria. In some embodiments, the other application is a first application (e.g., as discussed above with respect to 422 in FIG. 4). In some embodiments, the background process is a first background process (e.g., as discussed above with respect to 422 in FIG. 4). In some embodiments, the accessory management application initiates a third background process corresponding to a third application separate (and/or different) from the accessory management application and the first application, wherein the third background process is separate (and/or different) from the first background process. In some embodiments, the third background process is a simplified, device managed, process that has limited access and/or rights. In some embodiments, the third background process is managed by the third application. In some embodiments, the background process has a limited set of functionalities derived from the third application and/or the accessory management application. In some embodiments, the third application is another application associated with the second device (e.g., provides additional functionality to the second device). In some embodiments, the third application is associated with one or more accessory devices including the second device (e.g., another ecosystem of device is separate from the accessory management application and/or an ecosystem of device compatible with the accessory management application). In some embodiments, after initiating the third background process, in response to receiving the first accessory device information, and in accordance with the determination that the first portion of the first accessory device information satisfies the first set of one or more criteria and a third portion of the first accessory device information satisfies a third set of one or more criteria (e.g., as discussed above with respect to 422 in FIG. 4), the accessory management application provides, to the first background process, the first portion of the first accessory device information without providing, to the first background process, the third portion of the first accessory device information. In some embodiments, the third set of one or more criteria is at least partially defined by the third application. In some embodiments, the third set of one or more criteria is at least partially defined by the accessory management application (e.g., configured for the third application and/or to enable operability with the third application). In some embodiments, the third set of one or more criteria includes a criterion based on the first accessory device information (e.g., type, size, content, and/or privacy level). In some embodiments, the third set of one or more criteria includes a criterion that is satisfied when a portion of accessory device information corresponds to a particular device (e.g., a portion (e.g., the first portion and/or the second portion) of accessory device information satisfies the third set of one or more criteria when the portion corresponds to a particular device). In some embodiments, the third set of one or more criteria includes a criterion that is satisfied when a portion of accessory device information is a particular type of accessory device information (e.g., a portion (e.g., the first portion and/or the second portion) of accessory device information satisfies the third set of one or more criteria when the portion is a particular type of accessory device information). In some embodiments, the third set of one or more criteria includes a criterion that is satisfied when a portion of accessory device information is determined to correspond to information requested by the second application (e.g., a portion (e.g., the first portion and/or the second portion) of accessory device information satisfies the third set of one or more criteria when the portion is determined to correspond to information requested by the second application). In some embodiments, after initiating the third background process, in response to receiving the first accessory device information, and in accordance with the determination that the first portion of the first accessory device information satisfies the first set of one or more criteria and the third portion of the first accessory device information satisfies the third set of one or more criteria, the accessory management application provides, to the third background process, the third portion of the first accessory device information without providing, to the third background process, the first portion of the first accessory device information (e.g., as discussed above with respect to 422 in FIG. 4), wherein the third set of one or more criteria is different from the first set of one or more criteria, and wherein the third portion of the first accessory device information is different (and/or separate) from the first portion of the first accessory device information. In some embodiments, the third portion of the first accessory device information is a different subsection of the first accessory device information that is a different type of information, includes different content (e.g., different level of privacy and/or different limitation on information), and/or is differently processed than the other portions (e.g., the first portion and/or the second portion) of the first accessory device information.

In some embodiments, after receiving the first accessory device information, the accessory management application receives, from the second device, second accessory device information (e.g., as discussed above with respect to FIG. 3 and/or 418 in FIG. 4) different from the first accessory device information. In some embodiments, the second accessory device information includes the same type of accessory device information as the first accessory device information. In some embodiments, the second accessory device information includes different content than the first accessory device information (e.g., includes different type of information and/or includes a change in accessory information such as detecting a different error, change in environment, and/or change in state). In some embodiments, in response to receiving the second accessory device information, the accessory management application forgoes providing, to the background process, a (e.g., any) portion of the second accessory device information (e.g., as discussed above with respect to 422 in FIG. 4). In some embodiments, after the first device forgoes providing, to the background process, a portion of the second accessory device information, the first device deletes the second accessory device information (e.g., without providing a portion of the second accessory device information to a background process).

In some embodiments, the first device is in communication with one or more display generation components (e.g., as discussed above with respect to FIG. 3) (e.g., a display screen, a projector, a head mounted display, and/or a touch-sensitive display). In some embodiments, after (and/or in response to) receiving the first accessory device information (and/or in accordance with a determination that the first portion of the accessory device information satisfies the set of one or more criteria), the accessory management application displays, via the one or more display generation components, a representation (e.g., indication and/or user-interface element) of the first accessory device information (e.g., as discussed above with respect to FIG. 3) (e.g., the first portion and/or the second portion of the first accessory device information). In some embodiments, the representation of the first accessory device information includes a visual indication of content of the first accessory device information (e.g., what information is included and/or type of information included), about the first accessory device information (e.g., size and/or when the first accessory device information was received), and/or of a connection of the first accessory device information to the second device (e.g., type of the second device, name of the second device, and/or location of the second device). In some embodiments, the representation of the first accessory device information includes a user-interface element such as an icon and/or picture corresponding to the second device.

Note that details of the processes described above with respect to process 500 (e.g., FIG. 5) are also applicable in an analogous manner to other processes described herein. For example, process 900 optionally includes one or more of the characteristics of the various processes described above with reference to process 500. For example, the accessory device information of process 500 can include the emergency condition of process 900. For brevity, these details are not repeated herein.

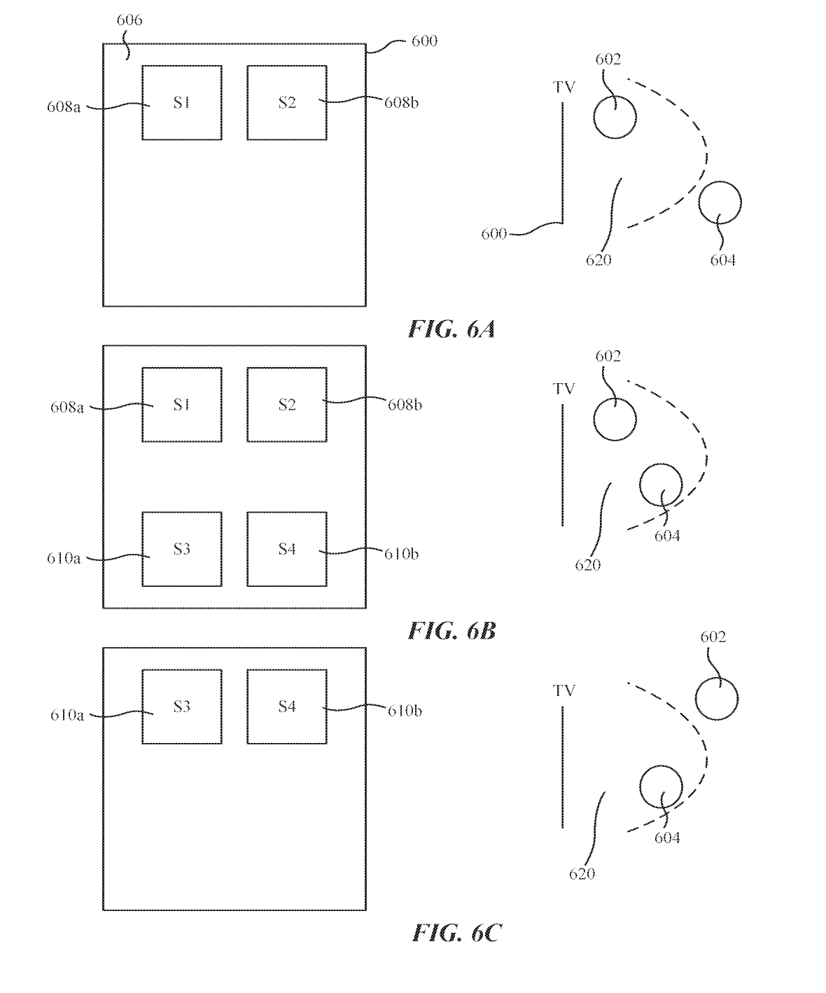

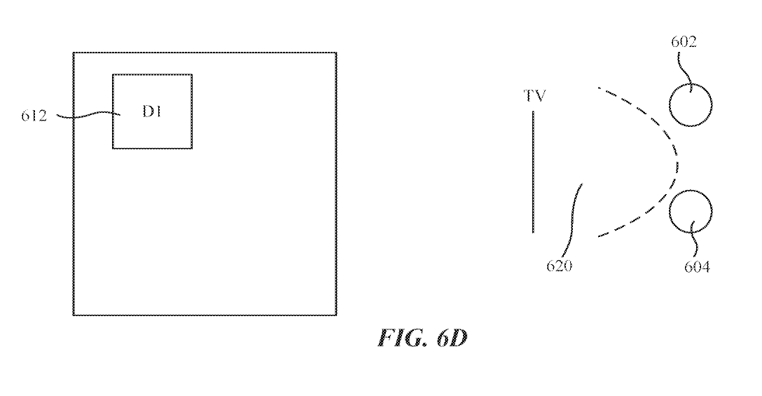

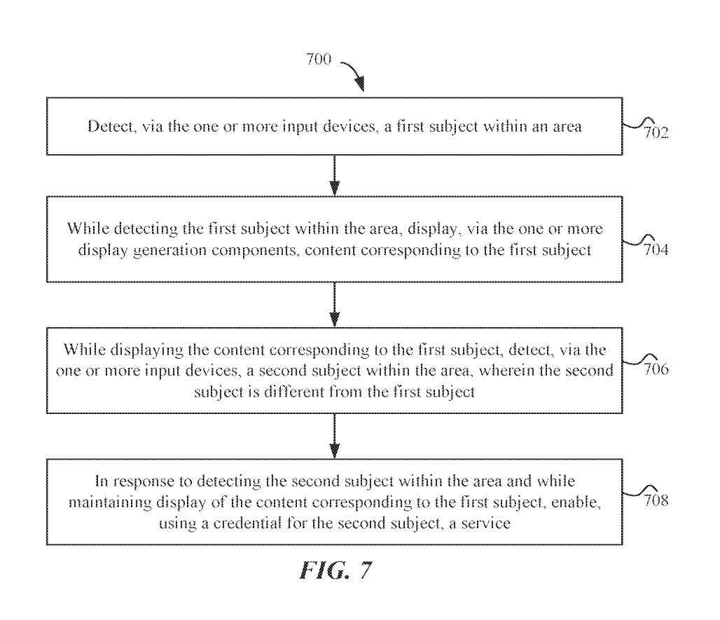

FIGS. 6A-6D illustrate a process for enabling services associated with a person based on the person being detected within an environment in accordance with some embodiments. The process in these figures is used to illustrate the processes described below, including the processes in FIG. 7.

FIGS. 6A-6D are split between a left portion and a right portion. The left portion of FIGS. 6A-6D illustrate exemplary user interfaces (e.g., service user interface 606) that are displayed by device 600. The right portion of FIGS. 6A-6D illustrate an environment including device 600 and a set of subjects (e.g., subject 602 and subject 604). As illustrated in FIGS. 6A-6D, the environment includes area 620 (e.g., a physical area within a threshold distance of device 600). In some embodiments, area 620 is a room and/or a physical location around device 600. For example, device 600 can be situated within a living room of a home and area 620 corresponds to the living room (e.g., a subject within the living room is considered within area 620). In some embodiments, area 620 is a zone and/or specified locality within the environment. For example, area 620 can be an entirety of an apartment and/or entirety of a home. For another example, area 620 can be a user-defined area within fifteen feet from device 600 (e.g., virtually defining a living room within an open floor plan home and/or defining a virtual bound to manage detection of individuals such as due to a reduced apartment size). As discussed below, device 600 manipulates a set of services accessible via device 600 based on presence of different subjects within area 620.

For discussion purposes, device 600 is a TV and/or a computer system that is in communication with a display situated within area 620. For example, device 600 can be a communal device that is used by people within an environment that device 600 is situated. As illustrated in FIGS. 6A-6D, device 600 includes a display that allows device 600 to display different content corresponding to different services as discussed further below. Further, device 600 includes one or more cameras that allow device 600 to detect subjects within the field of view of the one or more cameras. It should be recognized that device 600 is used for exemplary purposes and that device 600 can include different components such as different devices for detecting subjects (e.g., network connection and/or proximity connection components) and/or devices for outputting content (e.g., speakers). Further, it should be recognized that device 600 can be other types of devices instead of a TV.

As illustrated in FIG. 6A, subject 602 is within area 620. In some embodiments, device 600 detects subject 602 is within area 620 through the one or more cameras of device 600. For example, subject 602 can be a person and detecting that subject 602 is within area 620 can include recognizing the person using a user profile associated with subject 602 (e.g., matching one or more features of subject 602, such as via facial and/or voice recognition). For another example, subject 602 can be a device of a person and detecting subject 602 is within area 620 can include connecting to and/or receiving a communication from the device to obtain an identification of the person.

Further, as illustrated in FIG. 6A, subject 604 is not within area 620. Similarly to the discussion above, subject 604 might not be within area 620 based on not being within a threshold proximity to device 600, not being within a room with device 600, being outside a defined zone and/or bound specified to be area 620, and/or not being within a home and/or apartment associated with area 620. For example, subject 604 might not be within a living room that device 600 is located and, in response, device 600 is unable to detect and/or recognize subject 604. For example, subject 604 might not be within a living room that device 600 is located and, in response, device 600 is able to identify and/or recognize subject 604 but chooses not to use presence of subject 604 to determine what services to enable as discussed further below.

As illustrated in FIG. 6A, in response to subject 602 being within area 620 and subject 604 not being within area 620, device 600 enables a set of services (e.g., as indicated by service 608a and service 608b within services user interface 606) associated with subject 602. In some embodiments, subject 602 (and/or a device associated with subject 602) provides device 600 one or more credentials for accessing the set of services associated with subject 602. For example, device 600 can enable services accessible with a credential of subject 602, allowing subject 602 to access content from the set of services associated with subject 602 through device 600. In some embodiments, device 600 displays a user-interface object and/or representation for each service accessible by the one or more credential associated with subject 602. For example, device 600 can display an icon and/or logo associated with service 608a and service 606b in response to enabling service 608a and service 608b. For another example, device 600 can display content accessibly by each service (e.g., a TV show or movie cover art and/or representative image) in response to enabling service 608a and service 608b. For another example, device 600 displays recommended content and/or favorited content from service 608a and/or service 608b corresponding to subject 602 in response to enabling service 608a and service 608b. In some embodiments, service 608a and service 608b are streaming and/or content services. For example, service 608a and/or service 608b can be content streaming services that provide content such as TV shows, movies, and/or other pieces of media. As discussed above, device 600 does not detect subject 604 within area 620 and, in response, device 600 does not enable a set of services associated with subject 604.

In some embodiments, while service 608a and/or service 608b are enabled, device 600 detects an input directed to service 608a (e.g., a voice input requesting service 608a and/or an input directed to a representation of service 608a in services user interface 606) and, in response, launches service 608a. In some embodiments, launching service 608a includes logging into service 608a with the credential associated with subject 602. In some embodiments, after launching service 608a, device 600 displays content accessible through service 608a. For example, device 600 can display a set of TV shows, movies, and/or other content that can be streamed to device 600 for playback using service 608a.

At FIG. 6B, while the set of services associated with subject 602 are enabled, device 600 detects subject 604 within area 620. Similarly to the discussion above with respect to detection of subject 602, device 600 can detect subject 604 through the one or more cameras of device 600 and/or through connecting to a device.

As illustrated in FIG. 6B, in response to detecting subject 604 within area 620, device 600 enables a set of services (e.g., as indicated by service 610a and/or service 610b within services user interface 606) associated with subject 604. Similarly to the discussion above with respect to the set of services associated with subject 602, device 600 enables the set of services associated with subject 604 by using one or more credentials associated with subject 604. At FIG. 6B, service 610a and service 610b are separate (and/or different) from service 608a and service 608b (e.g., as indicated by the separate representations of service 608a, service 608b, service 610a, and service 610b within services user interface 606). For example, each service (e.g., service 608a, service 608b, service 610a, and/or service 610b) provides access to different content and/or different types of content (e.g., each service is a different content streaming platform with a library of TV shows and/or movies). In some embodiments, service 610a and/or service 610b provide different accounts for service 608a and/or service 608b rather than separate service. For example, while enabling service 608a and service 610b, device 600 enables another account for service 608a in response to detecting subject 604 (e.g., service 608a is associated with subject 602 and service 610b is associated with subject 604 but correspond to a common service).

While it is illustrated that subject 602 and subject 604 each provide two services (and/or each have credentials enabling two services), it should be recognized that less and/or additional services can be enabled per subject. For example, at FIG. 6B, in response to detecting an input to scroll down service user interface 606, device 600 can display one or more additional services enabled by subject 604. For another example, in response to detecting another subject within area 620, device 600 can enable a single service (e.g., different from the services associated with subject 602 and/or subject 604) accessible by a credential of the other subject.

In some embodiments, device 600 does not enable the set of services associated with subject 604 until confirmed by a prompt (e.g., output by a device associated with subject 604 or output by device 600 for subject 604 to confirm via device 600). For example, before enabling service 610a and service 610b, a device associated with subject 604 can output a prompt to confirm whether to share the one or more credentials of subject 604 with device 600 and, in response to detecting an acceptance of the prompt, the device associated with subject 604 provides device 600 with the one or more credentials of subject 604. In such an example, in response to detecting a declining of the prompt and/or subject 604 not accepting the prompt within a threshold amount of time, the device associated with subject 604 does not provide device 600 with the one or more credentials of subject 604 and the set of services is not enabled on device 600.

In some embodiments, in response to detecting subject 604, device 600 does not enable any new services. For example, subject 604 does not provide one or more credentials to enable a new service (e.g., provides credentials but the credentials correspond to the same services as provided by subject 602 and/or does not provide any credentials to device 600) and, in response, device 600 maintains the set of services enabled by subject 602. For another example, subject 604 provides one or more credentials for existing services (e.g., service 608a and/or service 608b) and, in response, device 600 maintains the services enabled by subject 602 and enables selection of either the credential associated with subject 602 and/or the credential associated with subject 604 (e.g., after launching service 608a and/or service 608b as discussed above). In some embodiments, device 600 selectively switches between a credential provided by subject 602 and a credential provided by subject 604 for a common service. For example, after (and/or while) launching service 608a, device 600 determines that a credential corresponding to subject 602 is of a higher tier than a credential corresponding to subject 604 for service 608a. For another example, while (and/or after) launching service 608a, device 600 detects that subject 604 is the primary user of device 600 and/or that subject 604 is controlling device 600 (e.g., through a device corresponding to subject 604 and/or through a remote associated with device 600) and, in response, device 600 uses a credential corresponding to subject 604 for service 608a.

While the set of services (e.g., service 608a, service 608b, service 610a, and service 610b) associated with subject 602 and subject 604 are enabled, device 600 detects that subject 602 is no longer within area 620 while continuing to detect subject 604 within area 620. Similarly to the discussion above with respect to detecting subject 602, device 600 can detect that subject 602 is no longer within area 620 based on no longer detecting subject 602 within the one or more cameras and/or based on no longer detecting a connection between device 600 and subject 602 (e.g., subject 602 is a device of a person).

As illustrated in FIG. 6C, in response to no longer detecting subject 602 within area 620 while continuing to detect subject 604 within area 620, device 600 disables service 608a and service 608b (e.g., as indicated by the lack of service 608a and service 608b within services user interface 606) and maintains the set of services (e.g., service 610a and service 610b) associated with subject 604. In some embodiments, disabling the set of services associated with subject 602 includes deleting the one or more credentials provided by subject 602 (e.g., the one or more credentials that enabled service 608a and/or 608b). In some embodiments, while (and/or after) leaving area 620, a device associated with subject 602 (and/or subject 604) revokes the set of services and/or revokes the one or more credentials enabling the set of services. In some embodiments, in response to no longer detecting subject 602 within area 620, device 600 deletes information corresponding to subject 602 (e.g., profile settings, personal information, and/or device settings). For example, while detecting subject 602, subject 602 alters one or more device settings on device 600 and, after no longer detecting subject 602, device 600 can revert and/or delete information stored for subject 602’s preference for the one or more device settings. For another example, device 600 can delete usage information corresponding to subject 602’s use of service 608a and service 608b (e.g., service subject 602 uses most often, content accessed by subject 602 through one of the services, and/or other usage information linked to subject 602).

In some embodiments, in response to no longer detecting subject 602 within area 620, device 600 terminates a connection shared between device 600 and a device associated with subject 602. For example, after device 600 no longer detects subject 602 within area 620, device 600 can terminate the connection with subject 602 even though device 600 is able to maintain the connection (e.g., subject 602 left a living room but is close enough to maintain a Bluetooth connection). In some embodiments, before terminating the connection between device 600 and the device associated with subject 602, the device associated with subject 602 outputs a prompt to provide the set of services associated with subject 602 for a temporary amount of time. For example, after subject 602 is no longer detected within area 620, subject 602 confirms that device 600 can maintain the set of services associated with subject 602 for a temporary amount of time and, in response, device 600 does not terminate the connection with the device associated with subject 602 and maintains the set of services associated with subject 602. However, after maintaining the set of services associated with subject 602, device 600 detects that the temporary amount of time has passed and, in response, device 600 disables the set of services and/or terminates the connection between device 600 and the device associated with subject 602.

In some embodiments, in response to no longer detecting subject 602 and continuing to detect subject 604, device 600 assigns subject 604 to be primary user of device 600. In some embodiments, in response to subject 604 becoming the primary user of device 600, device 600 prioritizes the one or more credentials provided by subject 604. For example, while launching a service (e.g., service 610a and/or 610b), device 600 can use a credential associated with subject 604 even though there are other credentials provided by one or more other subjects for the service. In some embodiments, in response to subject 604 becoming the primary user of device 600, device 600 alters services user interface 606. For example, in response to subject 604 becoming the primary user, device 600 can update service user interface 606 to match one or more preferences and/or settings of subject 604 (e.g., service order, layout, and/or favorited services). For another example, in response to subject 604 becoming the primary user, device 600 can alter one or more portions of content within service user interface 606 to be content associated with subject 604. For another example, device 600 can display a cover image and/or representation corresponding to content recently viewed by subject 604 in response to subject 604 becoming the primary user. For another example, device 600 can display recommended content and/or favorited content corresponding to subject 604 in response to subject 604 becoming the primary user.

While the set of services associated with subject 604 are enabled (and/or after disabling the set of services associated with subject 602), device 600 no longer detects subject 604 within area 620. Similarly to the discussion above with respect to no longer detecting subject 602 within area 620, device 600 can detect that subject 604 is no longer within area 620 based on no longer detecting subject 604 via the one or more cameras and/or based on no longer detecting a connection between device 600 and subject 604.

As illustrated in FIG. 6D, in response to no longer detecting subject 604 within area 620, device 600 disables the set of services associated with subject 604 (e.g., as indicated by the lack of service 610a and 610b within services user interface 606). Similarly to the discussion above with respect to no longer detecting subject 602, device 600 can delete information corresponding to subject 604, delete and/or revoke one or more credentials associated with subject 604, and/or cease display of services and/or content accessibly by the one or more credentials associated with subject 604. In some embodiments, in response to no longer detecting subject 604, device 600 terminates communication with subject 604 (and/or a device associated with subject 604). For example, device 600 detects that subject 604 is outside of a detection threshold for one or more cameras of device 600 and, in response, device 600 can terminate a Bluetooth connection shared between device 600 and a device associated with subject 604. As discussed above, before terminating a connection with device 600, subject 604 can temporarily provide device 600 the set of services and/or the one or more credentials for a temporary amount of time.

As illustrated in FIG. 6D, in response to no longer detecting subject 604 within area 620, device 600 enables service 612 (e.g., as indicated by service 612 within services user interface 606). In some embodiments, default service 612 is not associated with a subject. For example, content accessible by default service 612 does not require an account such as basic cable, content accessibly freely on the internet, and/or content stored locally on device 600. In some embodiments, default service 612 is a service provided by device 600. For example, default service 612 is a service provided by a manufacturer of device 600 and provides device information, service information, and/or maintenance information.

FIG. 7 is a flow diagram illustrating a process (e.g., process 700) for enabling a service based on a detected subject in accordance with some embodiments. Some operations in process 700 are, optionally, combined, the orders of some operations are, optionally, changed, and some operations are, optionally, omitted.

As described below, process 700 provides an intuitive way for enabling a service based on a detected subject. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication with one or more input devices (e.g., as discussed above with respect to FIG. 6A) (e.g., a camera, a depth sensor, a microphone, a wireless communication device, a network device, and/or a signal receiver) and one or more display generation components (e.g., as discussed above with respect to FIG. 6A) (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, an electronic device, and/or a personal computing device.

The computer system detects (702), via the one or more input devices, a first subject (e.g., 602) (e.g., a person and/or a personal device of a person) within an area (e.g., 620) (e.g., a locality proximate to the computer system and/or within a certain distance from the computer system). In some embodiments, the area is based on connectivity to the computer system (e.g., at a distance that the computer system is able to maintain a connection and/or at a distance that the computer system identifies the first subject). In some embodiments, the first subject is a known subject (e.g., the computer system recognizes the first subject and/or a device associated with the first subject) and/or an unknown subject that authenticates with the computer system (e.g., a new subject and/or unknown subject communicates information for validating and/or securely passing credentials to the computer system).

While (and/or in response to or after) detecting the first subject within the area, the computer system displays (704), via the one or more display generation components, content (e.g., 608a and/or 608b) corresponding to the first subject. In some embodiments, the content is accessible by (e.g., corresponding to and/or associated with) a credential for the first subject (e.g., content of a service connected using the credential). In some embodiments, the content includes a preview of a service accessible by a credential for the first subject. In some embodiments, the content includes one or more pieces of content from a service connected using a credential for the first subject. In some embodiments, the credential for the first subject includes a login, an account, and/or authentication information corresponding to the first subject and one or more content services (e.g., streaming services and/or internet-based services).

While displaying the content corresponding to (e.g., associated with, from a credential of, and/or selected by) the first subject (and/or while continuing to detect the first subject within the area and/or while continuing to detect the first subject interact with the computer system), the computer system detects (706), via the one or more input devices, a second subject (e.g., 604) (e.g., a person and/or a personal device of a person) within the area, wherein the second subject is different from the first subject. In some embodiments, the content corresponds to the first subject because the content is enabled by a credential and/or set of credentials (e.g., accounts, and/or tokens). In some embodiments, the content corresponds to the first subject because the computer system detects an input from the first subject (e.g., an input requesting content and/or services). In some embodiments, the second subject is a known subject (e.g., the computer system recognizes the second subject and/or a device associated with the second subject) and/or an unknown subject that authenticates with the computer system (e.g., a new subject and/or unknown subject communicates information for validating and/or securely passing credentials to the computer system).

In response to detecting the second subject within the area (and/or while continuing to detect the first subject within the area, while continuing to detect the first subject interact with the computer system, and/or while not detecting that the second subject is interacting with the computer system) and while maintaining display of the content corresponding to the first subject, the computer system enables (708), using a credential (e.g., an account, a login, a username, a password, authentication information corresponding to the second subject and one or more content services (e.g., streaming services and/or internet-based services), and/or a permission to use one or more services) for the second subject (e.g., as discussed above with respect to FIG. 6B), a service (e.g., 610a and/or 610b) (e.g., access to content, access to one or more functions and/or operations, access to one or more applications, and/or access to data) (and/or use of the service by the first subject). In some embodiments, the service is a streaming service (e.g., a content streaming service and/or remote content host), internet service (e.g., web browser and/or set of web pages), cable service, and/or network service (e.g., a service and/or application hosted by and/or provided by another computer system on a network). In some embodiments, the service is enabled to be used by the first subject. In some embodiments, the service is not accessible before detecting the second subject within the area. In some embodiments, the service is not accessible by a credential for the first subject.

In some embodiments, the one or more input devices include one or more cameras (e.g., as discussed above with respect to FIG. 6A). In some embodiments, detecting the first subject includes detecting, via the one or more cameras, a first person (e.g., 602). In some embodiments, detecting the second subject includes detecting, via the one or more cameras, a second person (e.g., 604). In some embodiments, the second person is different from the first person. In some embodiments, while detecting the first person and/or the second person, the computer system recognizes that the first person and/or the second person correspond to a first user profile and/or second user profile (e.g., the computer system matches one or more facial features of the first person and/or the second person to the first user profile and/or the second user profile). In some embodiments, detecting the first person and/or the second person includes obtaining a set of credentials associated with the first person and/or the second person (e.g., a set of credentials associated with the person through one or more facial features and/or associated with the person through a connected user profile). In some embodiments, in response to detecting the first person and/or the second person, the computer system obtains a set of credentials associated with the first person and/or the second person (e.g., a set of credentials associated with the person through one or more facial features and/or associated with the person through a connected user profile).

In some embodiments, detecting the first subject includes detecting, via a wireless communication channel (e.g., as discussed above with respect to FIG. 6A), a first device (e.g., 602) (e.g., associated with the first subject). In some embodiments, detecting the second subject includes detecting, via a wireless communication channel, a second device (e.g., 604) (e.g., associated with the second subject). In some embodiments, the second device is different from the first device. In some embodiments, the wireless communication channel used to detect the first device is a proximity-based communication channel. In some embodiments, the first subject is the first device. In some embodiments, the second subject is the second device. In some embodiments, the computer system is continuously (e.g., at some interval) searching for other devices (e.g., the first device and/or the second device) and/or continuously (e.g., at some interval) requesting a credential through a wireless communication channel (e.g., the first device and/or the second device receive a request for credentials and the computer system receives, from the first device and/or the second device, information and/or a credential). In some embodiments, the computer system detects the first device and/or the second device in response to the first device and/or the second device connecting to and/or communicating through a wireless communication channel. In some embodiments, the first device and/or the second device are personal devices associated with a first user and/or a second user (e.g., the first subject and/or the second subject is logged in on the first device and/or the second device and/or the first device and/or the second device has a first user profile and/or a second user profile active that corresponds to the first subject and/or the second subject). In some embodiments, the first device and/or the second device contain a set of one or more credentials for services and/or content that can be displayed by the computer system (e.g., a streaming service and/or a media service). In some embodiments, in response to connecting via the wireless connection, the first device and/or the second device share a set of one or more credentials and/or services accessibly by one or more credentials associated with the first user and/or the second user.

In some embodiments, after detecting the second subject and before enabling the service, the computer system displays (and/or causes display of), via one or more display generation components (e.g., as discussed above with respect to FIG. 6B) (e.g., a display screen, a projector, a head mounted display, and/or a touch-sensitive display) of the second device, a confirmation (e.g., as discussed above with respect to FIG. 6B) (and/or a confirmation to provide a credential for a service and/or a confirmation to share access to one or more services), wherein the second device provides the computer system the credential in response to detecting an input (e.g., a tap and/or voice input) corresponding to (e.g., directed to and/or related to) the confirmation. In some embodiments, the confirmation is a user-interface that includes a control and/or indication that includes a control (e.g., the control corresponds to an acceptance of the confirmation). In some embodiments, after displaying the confirmation, the second device detects an input correspond to the confirmation and, in response, provides the computer system the credential for enabling the service. In some embodiments, after displaying the confirmation, the second device detects that a threshold amount of time has passed since displaying the confirmation and, in response, the second device forgoes provision of, to the computer system, the credential.

In some embodiments, after displaying the content corresponding to the first subject, the computer system detects, via the one or more input devices, a lack of the first subject within the area (e.g., as discussed above with respect to FIG. 6C) (and/or no longer detecting the first subject within the area). In some embodiments, detecting the lack of the first subject within the area includes detecting, via the one or more input devices, the first subject move from within a predefined proximity of the computer system to outside of the predefined proximity and/or detecting, via the one or more input devices, the first subject move from within the area to outside of the area. In some embodiments, in response to detecting the lack of the first subject within the area (and/or while continuing detection of the second subject within the area), the computer system ceases display of, via the one or more display generation components, the content corresponding to the first subject (e.g., as discussed above with respect to FIG. 6C). In some embodiments, while detecting the second subject within the area and in response to detecting the lack of the first subject within the area, the computer system displays content corresponding to the second subject and/or changes the content corresponding to the first subject to content corresponding to the second subject.

In some embodiments, in response to detecting the lack of the first subject within the area, the computer system disables a service (e.g., as discussed above with respect to FIG. 6C) that uses (and/or that is enabled via and/or corresponds to) a credential of the first subject (e.g., as discussed above with respect to FIG. 6C) (e.g., and that does not use a credential of the second subject). In some embodiments, the content corresponding to the first subject is content from the service that uses the credential of first subject. In some embodiments, the service that uses the credential of first subject includes a content streaming service, a media service, and/or a tv service. In some embodiments, the credential of the first subject is an account, authentication token and/or key, and/or passkey (e.g., combination of username and password and/or encrypted passkey) for one or more services.

In some embodiments, while displaying the content corresponding to the first subject, the first subject is a primary subject (e.g., as discussed above with respect to FIG. 6B) (and/or a primary user of the computer system). In some embodiments, the primary subject is a user profile that controls device settings (e.g., text size, number of services displayed, and/or favorited services), displayed content (e.g., previously viewed content, favorited content, and/or last viewed content), and/or general appearance of the computer system (e.g., background images, color attributes, and/or font). In some embodiments, the primary subject overrides other subjects (e.g., a service enabled by a credential of the primary subject overrides a service enabled by a credential of another subject, the primary subject’s credential is used to enable a service shared among the primary subject and another subject, and/or a credential of the primary subject is used prior to other subjects). In some embodiments, while detecting the first subject and the second subject and in accordance with a determination that the second subject is the primary subject (and/or that the subject is no longer the primary subject), the computer system ceases display of, via the one or more display generation components, content corresponding to the first subject (e.g., as discussed above with respect to FIG. 6C). In some embodiments, the determination that the second subject is the primary subject includes a determination that the second subject is closer to the computer system than the first subject. In some embodiments, the determination that the second subject is the primary subject includes a determination that the second subject is looking at the computer system while the first subject is not looking at the computer system. In some embodiments, the determination that the second subject is the primary subject includes a determination that the second subject is closer to a middle of a field of view of the computer system than the first subject. In some embodiments, the determination that the second subject is the primary subject includes a determination that the first subject has not interacted with (and/or looked toward) the computer system within a predefined period of time (e.g., 1 minute to 10 minutes). In some embodiments, the determination that the second subject is the primary subject is based on detecting, via the one or more input devices, an input (e.g., a tap input and/or voice input) corresponding to (e.g., related to and/or associated with) a request to make the second subject the primary subject. In some embodiments, while detecting the first subject and the second subject and in accordance with the determination that the second subject is the primary subject, the computer system displays, via the display generation component, content corresponding to the second subject (e.g., as discussed above with respect to FIG. 6C). In some embodiments, the computer system alters one or more device settings to align with one or more settings set by the primary subject in accordance with the determination that the second subject is the primary subject.

In some embodiments, while detecting the first subject and the second subject and in accordance with a determination that the second subject is the primary subject (e.g., as discussed above with respect to FIG. 6C), the computer system forgoes use of one or more device settings corresponding to (e.g., defined, selected, and/or chosen by) the first subject. In some embodiments, while detecting the first subject and the second subject and in accordance with the determination that the second subject is the primary subject, the computer system uses one or more device settings corresponding to (e.g., defined, selected, and/or chosen by) the second subject (e.g., as discussed above with respect to FIG. 6C). In some embodiments, the one or more device settings corresponding to the first subject include a device setting defining a text size, a device setting defining a number of services displayed, a device setting defining one or more favorited services, a device setting defining a background image, a device setting defining a color attribute, and/or a device setting defining a font.

In some embodiments, after enabling the service, the computer system detects, via the one or more input devices, a lack of the second subject within the area (e.g., as discussed above with respect to FIG. 6D) (and/or no longer detecting the second subject within the area). In some embodiments, detecting the lack of the second subject within the area includes detecting, via the one or more input devices, the second subject move from within a predefined proximity with the computer system to outside of the predefined proximity and/or detecting, via the one or more input devices, the second subject move from within the area to outside of the area. In some embodiments, in response to detecting the lack of the second subject within the area, the computer system disables access to (e.g., via and/or using the credential) the service (e.g., as discussed above with respect to FIG. 6D). In some embodiments, the computer system ceases displaying content from the service in response to detecting the lack of the second subject within the area (e.g., ending current playback and/or terminating a content stream). In some embodiments, the computer system disables access to the service by removing the credential corresponding to the second subject from the service.

In some embodiments, in response to detecting the lack of the second subject within the area, the computer system removes (and/or deletes) data corresponding to the second subject (e.g., as discussed above with respect to FIG. 6D) (e.g., content accessible via the credential of the second subject, the credential of the second subject, and/or information about the second subject’s usage of the computer system). In some embodiments, the data corresponding to the second subject includes one or more device settings and/or one or more preferences (e.g., layout of content and/or services and/or an appearance setting). In some embodiments, the data corresponding to the second subject includes information accessible by the computer system from a device corresponding to the second subject (e.g., an image, account information, and/or device information).

In some embodiments, after enabling the service, the computer system detects, via the one or more input devices, a lack of the second subject within the area (e.g., as discussed above with respect to FIG. 6D) (and/or no longer detecting the second subject within the area). In some embodiments, detecting the lack of the second subject within the area includes detecting, via the one or more input devices, the second subject move from within a predefined proximity with the computer system to outside of the predefined proximity and/or detecting, via the one or more input devices, the second subject move from within the area to outside of the area. In some embodiments, in response to detecting the lack of the second subject within the area, the computer system displays (and/or causes display of), via one or more display generation components of a device corresponding to the second subject (e.g., as discussed above with respect to FIG. 6D) (and/or of the second subject), a prompt for maintaining access to the service (e.g., as discussed above with respect to FIG. 6D) (e.g., for an amount of time, such as a temporary time and/or for a duration of a piece of content from the service). In some embodiments, in response to detecting an input accepting the prompt for maintaining access to the service (e.g., for the amount of time), the computer system retains access to the service enabled by the credential of the second subject. In some embodiments, after detecting that the amount of time has passed, the computer system revokes access to the service (and/or content provided by the service), removes information corresponding to the second subject, and/or changes one or more settings to correspond to the first subject or a currently detected subject.

In some embodiments, after enabling the service, the computer system detects, via the one or more input devices, a third subject (e.g., as discussed above with respect to FIG. 6B) within the area, wherein the third subject is different from the first subject and the second subject. In some embodiments, the third subject is a person and/or device associated with a person. In some embodiments, the third subject has a set of one or more credentials for services and/or content. In some embodiments, the services and/or content accessible by the computer system through the set of one or more credentials of the third subject are different from the services and/or content corresponding to the credential of the second subject. In some embodiments, in response to detecting the third subject within the area, the computer system enables, via a credential of the third subject, another service (e.g., as discussed above with respect to FIG. 6B) different from the service. In some embodiments, the other service is a different content service than the service (e.g., the other service enables access to a different set of content and/or content not provided by the service).

In some embodiments, after enabling the service, the computer system detects, via the one or more input devices, a fourth subject (e.g., as discussed above with respect to FIG. 6B) within the area, wherein the fourth subject is different from the first subject and the second subject. In some embodiments, the fourth subject is a person and/or device associated with a person. In some embodiments, the fourth subject has a set of one or more credentials for services and/or content. In some embodiments, the services and/or content accessible by the computer system through the set of one or more credentials of the fourth subject are different from the services and/or content corresponding to the credential of the second subject. In some embodiments, in response to detecting the fourth subject within the area, the computer system forgoes enabling, via a credential of the fourth subject, a (and/or any and/or an additional) service (e.g., as discussed above with respect to FIG. 6B). In some embodiments, forgoing enabling a service includes enabling another account and/or credential for an existing service (e.g., the fourth subject has a subscription to the service and the computer system can allow the fourth subject and/or the second subject to use their respective credential to access the service). In some embodiments, the fourth subject does not have access to any services and/or does not have any credentials for existing services.

In some embodiments, after enabling the service, the computer system detects, via the one or more input devices, a fifth subject (e.g., as discussed above with respect to FIG. 6B) within the area, wherein the fifth subject is different from the first subject and the second subject. In some embodiments, the fifth subject is a person and/or device associated with a person. In some embodiments, the fifth subject has a set of one or more credentials for services and/or content. In some embodiments, the services and/or content accessible by the computer system through the set of one or more credentials of the fifth subject are different from the services and/or content corresponding to the credential of the second subject. In some embodiments, in response to detecting the fifth subject within the area, the computer system updates, via a credential of the fifth subject (e.g., as discussed above with respect to FIG. 6B), the credential enabling the service to the credential of the fifth subject (e.g., instead of the credential of the second subject). In some embodiments, before changing the credential enabling the service to the credential of the fifth subject, the computer system displays, via the one or more display generation components, a prompt to change credentials. In some embodiments, after changing the credential enabling the service to the credential of the fifth subject, the computer system detects, via the one or more input devices, an input corresponding to a request to change the credential enabling the service to the credential of the second subject and, in response, changes the credential enabling the service to the credential of the second subject.

In some embodiments, the credential for the second subject is a first credential for the second subject. In some embodiments, in response to detecting the second subject within the area, the computer system enables, via a second credential for the second subject, another service (e.g., as discussed above with respect to FIG. 6B) different from the service. In some embodiments, the second credential is the first credential. In some embodiments, the second credential is different from the first credential. In some embodiments, after enabling the other service, the computer system displays content corresponding to the second subject obtained from the second service.

In some embodiments, after enabling the service, the computer system detects, via the one or more input devices, an input (e.g., as discussed above with respect to FIG. 6A) (e.g., tap input and/or voice input) corresponding to (e.g., directed to and/or requesting) the service. In some embodiments, the input corresponding to the service is an input corresponding to a request to launch the service and/or access content from the service. In some embodiments, the input is an input directed to an icon of the service. In some embodiments, the input is a voice request that references the service. In some embodiments, in response to detecting the input corresponding to the service, the computer system displays, via the one or more display generation components, one or more indications of content (e.g., as discussed above with respect to FIG. 6A) (and/or a set of content) accessible through the service. In some embodiments, the one or more indications of content are icons of content accessible by the services (e.g., image and/or video previews of content). In some embodiments, before displaying the one or more indications of content, the computer system displays, via the one or more display generation components, a prompt to select a credential for the service (e.g., selecting an account to use to access the content and/or selecting a credential of a set of credentials).

Note that details of the processes described above with respect to process 700 (e.g., FIG. 7) are also applicable in an analogous manner to other processes described herein. For example, process 1100 optionally includes one or more of the characteristics of the various processes described above with reference to process 700. For example, the service of process 700 can provide the second content of process 1100. For brevity, these details are not repeated herein.

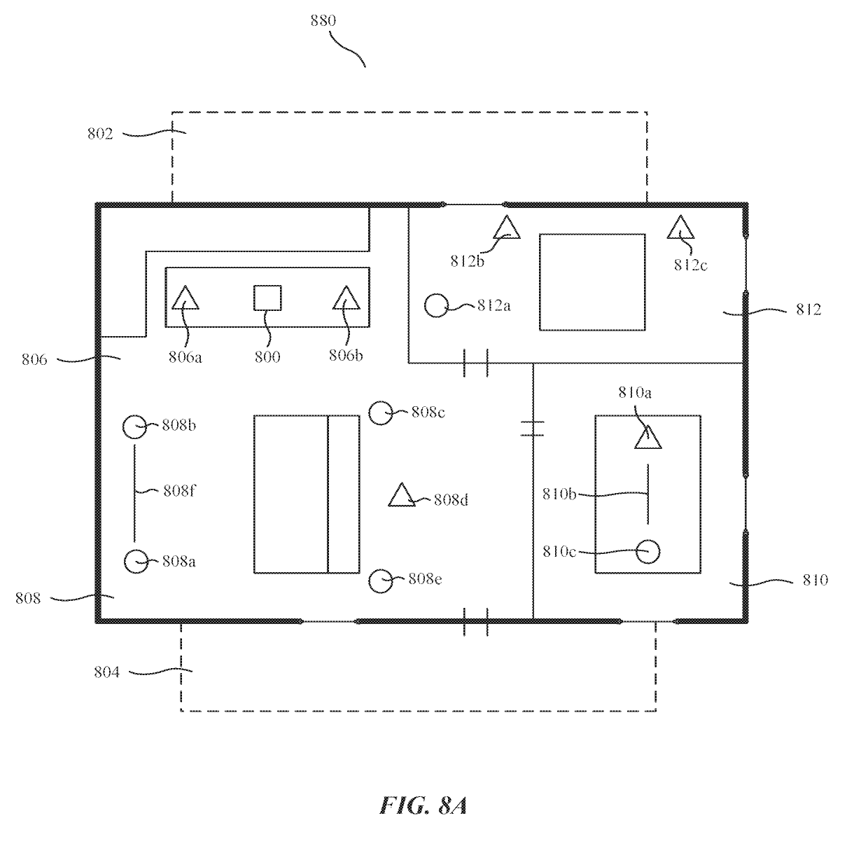

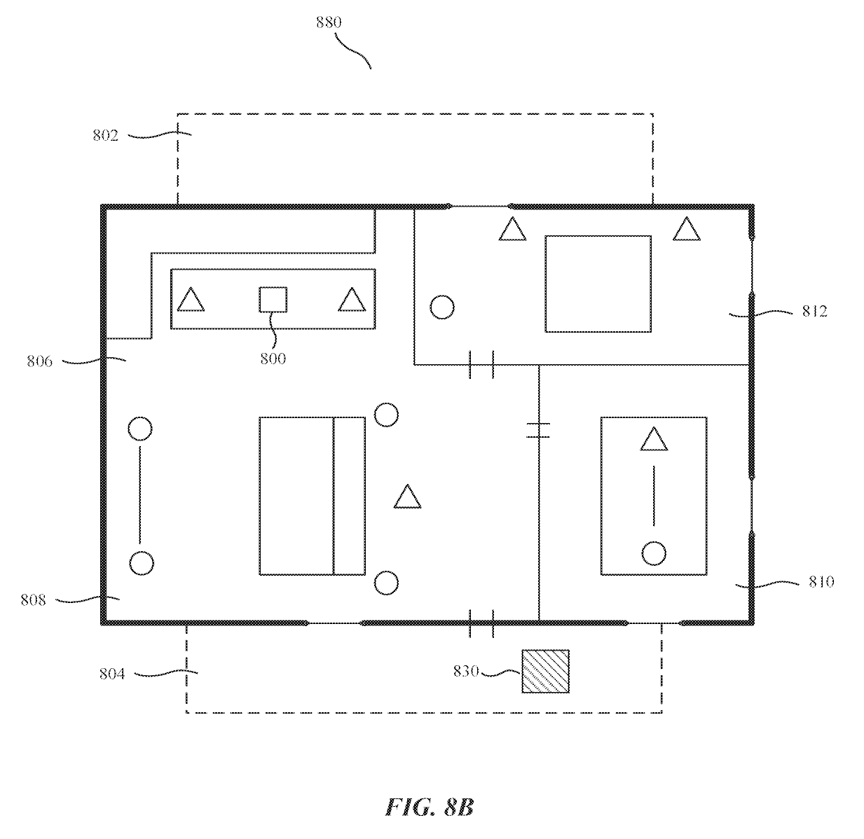

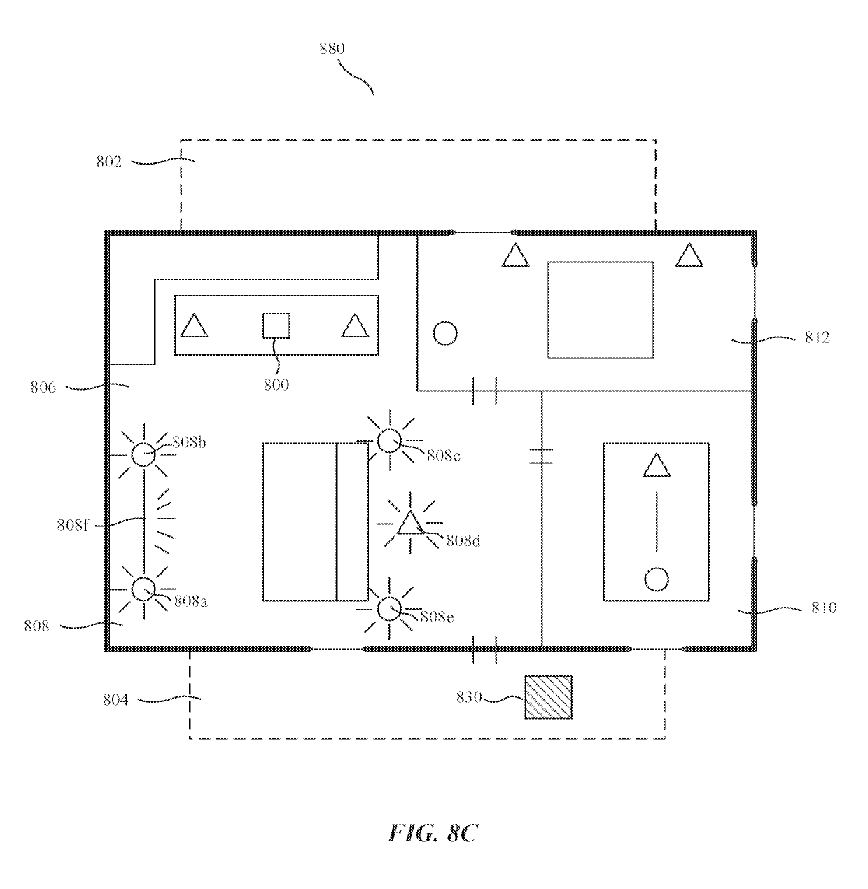

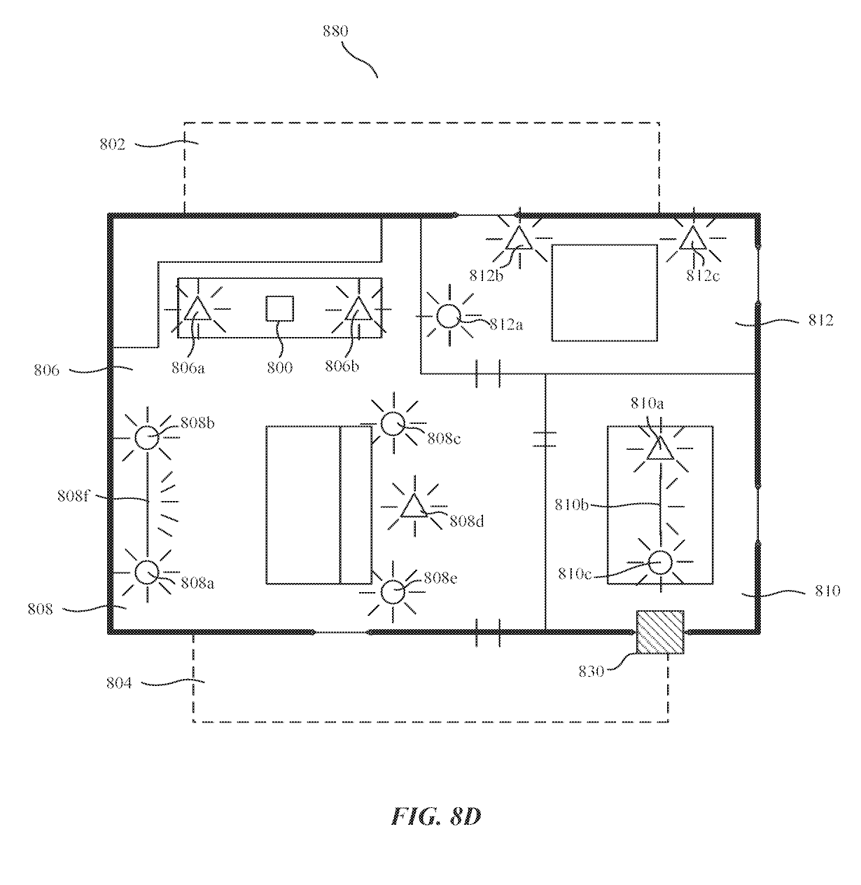

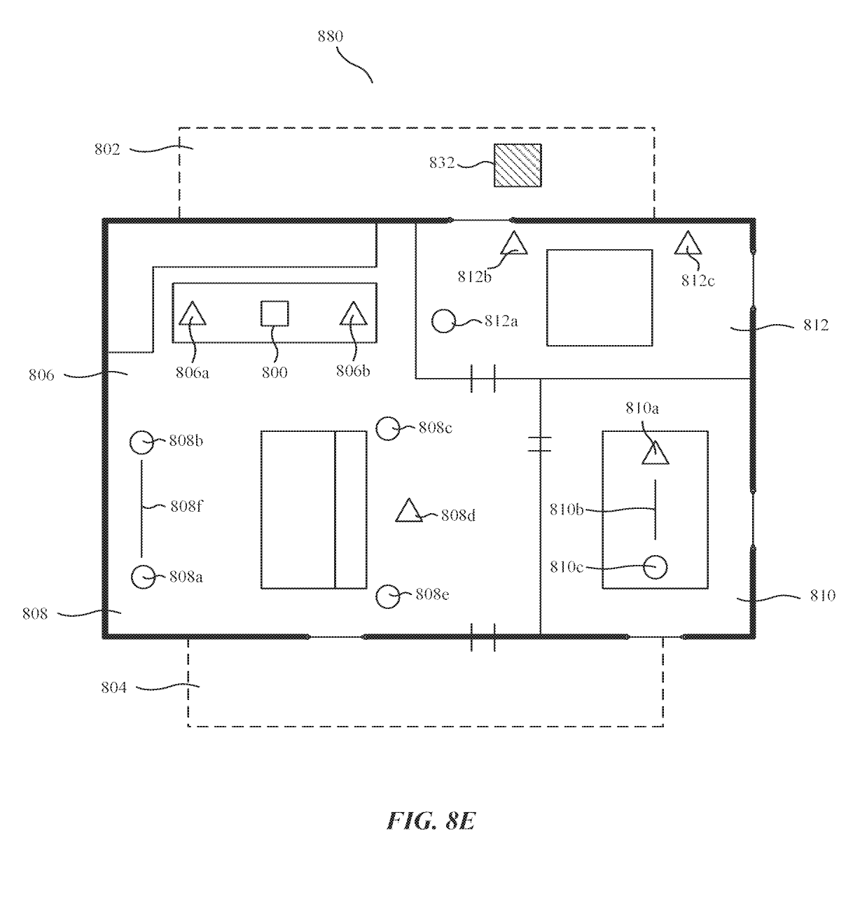

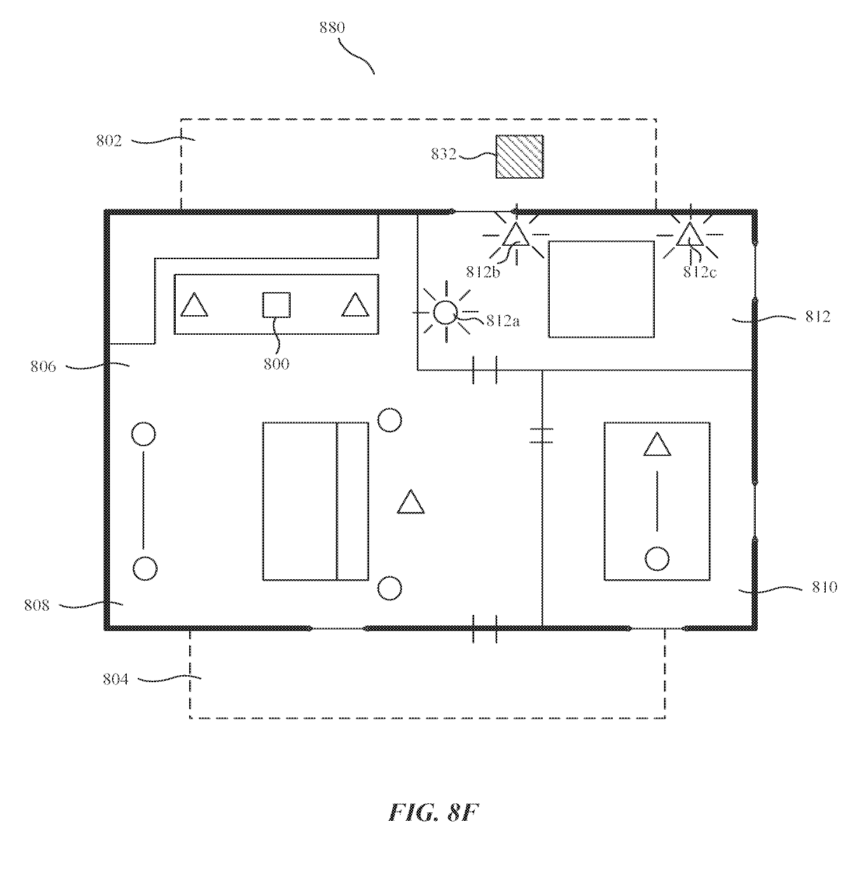

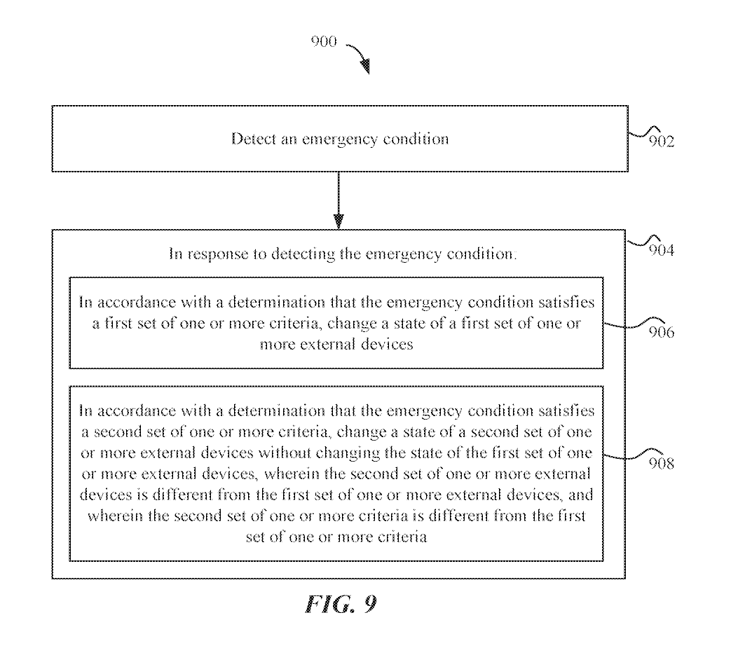

FIGS. 8A-8F illustrate an ecosystem of connected devices within a home in accordance with some embodiments. The ecosystem in these figures is used to illustrate the processes described below, including the processes in FIG. 9.

FIGS. 8A-8F illustrate home 880 that is separated into zones (e.g., front monitored zone 804 and back monitored zone 802) and/or rooms (e.g., kitchen 806, living room 808, office 810, and bedroom 812). In some embodiments, the rooms within home 880 are physically separate spaces within home 880 and/or virtually defined spaces within home 880. For example, the rooms of home 880 can be mapped according to a physical layout and/or floorplan of home 880. For another example, the rooms of home 880 can be configured based on user defined spaces within home 880 that do not follow the physical layout of home 880 (e.g., splitting a bedroom into two and/or separating a dining room from a kitchen within an open floor plan home). In some embodiments, the zones of home 880 are virtually defined spaces of home 880 and/or correspond to zones of detection associated with one or more devices (e.g., one or more cameras as discussed below). For example, front monitoring zone 804 and back monitoring zone 802 can be defined zones that cover entry points, can be commonly traveled walkways, and/or can be use defined areas such as including a front or back porch. For another example, a user can define a monitoring zone based on the detection abilities of devices within the zone (e.g., FOV of one or more cameras within the zone, as discussed below).

As illustrated in FIGS. 8A-8F, resident device 800 is positioned within kitchen 806 (e.g., affixed and/or placed on a countertop within kitchen 806) and acts as a central device for controlling and/or managing the accessories within home 880 (e.g., performing operations through the ecosystem of devices automatically based on detected events and/or directly by a user), as discussed further below. In some embodiments, a home management application can be used to perform operations and/or configure the ecosystem of devices. For example, resident device 800 and/or another device registered to the ecosystem of devices (e.g., has a credential for accessing the ecosystem of devices through a network and/or through the home management application) can adjust room assignments of devices within home 880 (e.g., adding speaker 808b and speaker 808c to play music while cooking and/or adding a whole home lighting assignment for all the light devices within home 880) and/or can create automations within home 880 through the home management application (e.g., arming one or more monitoring devices during a certain time of day and/or when all users leave home 880 and/or turning on light devices at a certain time of day). In some embodiments, devices within the ecosystem of devices are assigned to rooms through the home management application. For example, devices can be assigned to certain rooms to enable additional room-based functionality (e.g., alerting certain rooms when dinner is ready and/or dimming certain lights when playing a movie on a display within the room). For another example, assigning devices to rooms within home 880 can allow for dynamic responses to emergency conditions (e.g., playing back content within a room near the emergency condition and/or turning on lights to wake occupants due to an emergency condition), as discussed further below.

As illustrated in FIG. 8A, home 880 includes a variety of devices situated around home 880. As illustrated in FIG. 8A, kitchen 806 includes a set of lights (e.g., as indicated by light 806a and light 806b) and resident device 800, bedroom 812 includes a set of lights (e.g., 812b and 812c) and a speaker (e.g., 812a), living room 808 includes a light (e.g., 808d), a display (e.g., 808f), and a set of speakers (e.g., 808a, 808b, 808c, and 808e), and office 810 includes a speaker (e.g., 810c), a light (e.g., 810a), and a display (e.g., 810b). While the devices within home 880 are illustrated as lights, speakers, and displays, it should be recognized that other types of devices and/or other configurations of devices could be used within home 880. For example, additional speakers can be added to living room 808 and/or office 810. For another example, home 880 can be equipped with lock devices and/or entry detection devices (e.g., devices that detect whether a window has been opened).

In some embodiments, the devices within home 880 are devices within an ecosystem of devices (e.g., as discussed above with respect to FIG. 3). For example, devices (e.g., 806a-b, 808a-e, 810a-c, and/or 812a-c) within each room (e.g., kitchen 806, living room 808, office 810, and/or bedroom 812) of home 880 can be accessory devices included within the set of accessory devices as discussed above with respect to FIG. 3. In some embodiments, devices within the ecosystem of devices are managed and/or connected to resident device 800, as discussed above with respect to 302 in FIG. 3. For example, a user can add a new speaker to living room 808 through resident device 800.

At FIG. 8A, devices within home 880 are inactive and/or in a lower power state (e.g., as compared to FIG. 8D). In some embodiments, the devices are in the lower power state due to being idle and/or due to not detecting any emergency conditions for a threshold amount of time. For example, devices can go into a lower power state when past a certain time and/or when light within home 880 is reduced to a threshold level. For another example, after a predefined amount of time since detecting an emergency condition, devices within home 880 can transition into the lower power mode.

At FIG. 8B, while devices within home 880 are inactive, subject 830 is detected within zone 804. As illustrated in FIG. 8B, zone 804 is outside of home 880 and protrudes out, as discussed above. For example, zone 804 can be a front porch of home 880. As illustrated in FIG. 8B, zone 804 includes two entry points along the bottom side of home 880. In some embodiments, due to zone 804 being outside of home 880, zone 804 has a first security level (e.g., lower security level). In such embodiments, detected activity within a zone with the first security level do not immediately trigger an emergency condition (e.g., detect the activity for an amount of time and/or detect an escalation of the activity to trigger an emergency condition). As discussed below, some zones can have a higher security level (e.g., a second security level). For example, the inside of home 880 can be configured to have the higher security level.

In some embodiments, one or more accessory devices monitor zone 804 and trigger alerts based on a set of detection criteria. For example, the one or more accessory devices can monitor zone 804 to trigger an emergency condition when an unknown subject (e.g., person and/or animal) is within zone 804 for a predefined amount of time and/or when the unknown subject attempts to gain entry into zone 804 (e.g., through a locked front door and/or window). In some embodiments, the one or more accessory devices can include different types of devices, such as cameras, motion detection devices, and/or situational monitoring devices. For example, one or more cameras can include zone 804 within their field of view. For another example, one or more motion detection devices can cover zone 804. For another example, entry and/or glass break detection devices can be situated at the two entry points within zone 804.

At FIG. 8B, subject 830 is detected to correspond to an emergency condition. For example, subject 830 is an unknown subject and is detected for a predefined amount of time and/or is detected at a certain time of day (e.g., nighttime and/or early morning). In some embodiments, subject 830 is detected by the one or more cameras monitoring zone 804. In some embodiments, subject 830 is detected by one or more microphones (e.g., within the one or more cameras and/or separate from the one or more cameras). In some embodiments, detecting subject 830 includes recognizing (e.g., voice and/or facial) that subject 830 is an unknown subject. For example, subject 830 is recognized as a person that is not a member of the household and/or not a verified guest (e.g., a person given temporary access to home 880, such as a dog walker and/or visiting family member).

As illustrated in FIG. 8C, in response to detecting an emergency condition corresponding to subject 830 (e.g., subject 830 remains for longer than a threshold amount of time and/or is not recognized), resident device 800 activates a set of devices (e.g., light 808d, display 808f, speaker 808a, speaker 808b, speaker 808c, and speaker 808e) within living room 808. In some embodiments, activating the set of devices within living room 808 includes changing a power state of the set of devices (e.g., light 808d, display 808f, speaker 808a, speaker 808b, speaker 808c, and speaker 808e). For example, as illustrated in FIG. 8C, resident device 800 turns on light 808d within living room 808. In some embodiments, activating the set of devices within living room 808 includes outputting content via the set of devices (e.g., light 808d, display 808f, speaker 808a, speaker 808b, speaker 808c, and speaker 808e). For example, resident device 800 can initiate playback of a movie and/or other audiovisual content through display 808f, speaker 808a, speaker 808b, speaker 808c, and speaker 808e. For another example, resident device 800 can initiate playback of a fake dinner party through display 808f, speaker 808a, speaker 808b, speaker 808c, and speaker 808e (e.g., playing back an audio track of people talking and/or laughing to fake a gathering within living room 808). In some embodiments, resident device 800 activates the set of devices within living room 808 due to the proximity to subject 830. For example, resident device 800 attempts to scare away subject 830 by showing that subject 830 was detected. In some embodiments, resident device 800 activates the set of devices within living room 808 to fake occupancy within living room 808. For example, resident device 800 can activate devices in living room 808 to attempt to make subject 830 think that occupants are watching a movie and/or hosting a gathering within living room 808.

After resident device 800 activated the set of devices within living room 808, subject 830 escalates the situation by gaining access into and/or attempting to gain access into home 880 through an entry way within zone 804 (e.g., into office 810). In some embodiments, the entry way is a window, and resident device 800 is alerted to glass breaking and/or the window opening (e.g., while at night and/or while armed).

As illustrated in FIG. 8D, in response to escalation of the emergency condition corresponding to subject 830 (e.g., lingering within zone 804 to gain access into home 880), resident device 800 activates additional sets of devices. While illustrated in FIG. 8D as activating all devices within home 880, it should be recognized that this is one possible response to the escalation of the emergency condition corresponding to subject 830 and resident device 800 can activate different sets of devices based on differing criteria as discussed below. In some embodiments, resident device 800 activates a set of devices (e.g., light 810a, display 810b, and/or 810c) within office 810 in response to detecting subject 830 gain entry into office 810. For example, similarly as discussed above with respect to activating living room 808, resident device 800 can activate the set of devices within office 810 to scare away subject 830 by alerting subject 830 of their detection. In some embodiments, resident device 800 activates a set of devices (e.g., speaker 812a, light 812b, and/or 812c) within bedroom 812 to alert occupants of subject 830’s entry. For example, resident device 800 can play an audio alert through speaker 812a to inform occupants of the potential intruder. For another example, resident device 800 can turn on and/or strobe light 812b and light 821c to wake up sleeping occupants due to subject 830 being detected at night.

In some embodiments, in response to escalation of the emergency condition corresponding to subject 830, resident device 800 elevates a previously activated set of devices (e.g., speaker 808a, speaker 808b, speaker 808c, light 808d, speaker 808e, and/or display 808f). In some embodiments, elevating the previously activated set of devices includes activating additional devices within a common area within home 880. For example, resident device 800 can activate a set of devices within kitchen 806 based on its connection to living room 808 (e.g., within a common space with living room 808 and/or virtual connection within the home management application). In some embodiments, elevating the previously activated set of devices includes altering the previously activated set of devices (e.g., changing another state of the set of devices and/or changing a characteristic of playback of the set of devices). For example, resident device 800 can increase a volume of content output by speaker 808a, speaker 808b, speaker 808c, and/or speaker 808e within living room 808. For another example, resident device 800 can change content being output to more intense content and/or alternative occupancy content (e.g., changing from a fake audio track of a party to a fake audio track of people screaming intruder). After resident device 800 activates the additional sets of devices and/or elevates the previously activated set of devices, subject 830 leaves home 880 and is no longer detected (e.g., within home 880 and/or within zone 804).

At FIG. 8E, subject 830 is no longer detected within zone 804. In some embodiments, in response to no longer detecting the emergency condition, resident device 800 reduces the activation of the sets of devices. For example, resident device 800 can deactivate devices based on the devices’ activation (e.g., reverting devices within bedroom 812 and/or office 810 after living room 808). In some embodiments, in response to no longer detecting the emergency condition, resident device 800 initiates playback of an alert to inform occupants. For example, resident device 800 can output via one or more speakers within home 880 that the emergency condition has ended. In some embodiments, in response to no longer detecting subject 830 within zone 804 and/or in response to the emergency condition no longer being active, resident device 800 reverts the devices within home 880 to a lower power state as described above. For example, resident device 800 can return activated devices to their respective states from before the emergency condition (e.g., idle and/or monitoring).

As illustrated in FIG. 8E, after reverting the devices to the lower power states, subject 832 is detected within zone 802. Similarly as discussed above with respect to detecting subject 830 within zone 802, subject 832 is detected by one or more devices that monitor 832. For example, subject 832 can be detected by one or more cameras, motion detection devices, and/or other monitoring devices. In some embodiments, zone 802 is a back porch of home 880 that includes an entry way into home 880 (e.g., a backdoor).

At FIG. 8E, subject 832 triggers an emergency condition. For example, resident device 800 determines that subject 832 has been detected within zone 802 for a threshold amount of time, that subject 832 is an unknown subject, and/or that subject 832 is detected within zone 802 at a certain time of day (e.g., when occupants are home and/or nighttime). In some embodiments, subject 832’s activity within zone 802 causes an emergency condition. For example, subject 832 moves an object and/or is attempting to take an item from the back porch of home 880.

As illustrated in FIG. 8F, in response to the emergency condition corresponding to subject 832, resident device 800 activates a set of devices (e.g., speaker 812a, light 812b, and light 812c) within bedroom 812. In some embodiments, resident device 800 activates the set of devices within bedroom 812 due to bedroom 812’s proximity to zone 802. For example, as discussed above, resident device 800 can activate the set of devices within bedroom 812 to attempt to scare away subject 832. For another example, as discussed above, resident device 800 can activate the set of devices within bedroom 812 to fake occupancy near subject 832 to prevent a potential intruder from thinking that home 880 is unoccupied. In some embodiments, resident device 800 activates the set of devices within bedroom 812 due to occupancy of bedroom 812. For example, resident device 800 can turn on light 812b and light 812c to wake up occupants that are sleeping within bedroom 812. For another example, resident device 800 can initiate playback of an alert and/or alarm through speaker 812a to alert the occupants of subject 832.

FIG. 9 is a flow diagram illustrating a process (e.g., process 900) for altering a state of a set of external devices based on an emergency condition in accordance with some embodiments. Some operations in process 900 are, optionally, combined, the orders of some operations are, optionally, changed, and some operations are, optionally, omitted.

As described below, process 900 provides an intuitive way for altering a state of a set of external devices based on an emergency condition. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., 800). In some embodiments, the computer system is a watch, a phone, a tablet, a fitness tracking device, a processor, a head-mounted display (HMD) device, a communal device, a media device, a speaker, a television, an electronic device, and/or a personal computing device.

The computer system detects (902) an emergency condition (e.g., as discussed above with respect to 830 in FIG. 8C and/or 832 in FIG. 8F) (e.g., an activity, a subject, a person, and/or an event). In some embodiments, the emergency condition is a predefined event and/or situation (e.g., the computer system set to alert and/or change a state of another device based on a certain situation occurring). In some embodiments, the emergency condition is an alarm when detecting a subject at a certain point and/or zone of an environment (e.g., a subject in a backyard and/or on a back porch at night), broken glass, opened entry way (e.g., a door left open and/or a window opened from outside), and/or natural condition such as a water pipe burst, tree falling, and/or fire. In some embodiments, the computer system polls to detect (e.g., continuously and/or at a certain rate) the emergency condition. In some embodiments, the computer system detects the emergency condition from the external device via a network of devices (e.g., a home network and/or network of devices) and/or an accessory ecosystem (e.g., a mesh network of accessory devices and/or a set of accessory devices communicating over a certain accessory protocol). In some embodiments, the external device is an accessory device (e.g., a device managed and/or used by one or more computer systems). In some embodiments, detecting the emergency condition includes recognizing an activity within an environment, recognizing an unknown subject within an environment, detecting breaking glass, and/or detecting an opened access point such as a window or door.

In response to (904) detecting the emergency condition, in accordance with a determination that the emergency condition satisfies a first set of one or more criteria (e.g., as discussed above with respect to FIG. 8C), the computer system changes (906) a state of a first set of one or more external devices (e.g., 806a and 806b, 808a-808f, 810a-810c, and/or 812a-812c). In some embodiments, the computer system changes the state of the first set of one or more external devices through a network of devices (e.g., the computer system requests an accessory management application and/or another device to alter the state of the first set of one or more external devices). In some embodiments, the first set of one or more external devices includes the external device that sent the emergency condition. In some embodiments, the first set of one or more external devices are separate from the external device that sent the emergency condition. In some embodiments, the first set of one or more devices are proximate to the emergency condition (e.g., turning on lights near an intruder and/or playing audio near an exterior wall).

In response to (904) detecting the emergency condition, in accordance with a determination that the emergency condition satisfies a second set of one or more criteria (e.g., as discussed above with respect to FIGS. 8C and/or 8D), the computer system changes (908) a state of a second set of one or more external devices (e.g., 806a and 806b, 808a-808f, 810a-810c, and/or 812a-812c) without changing the state of the first set of one or more external devices, wherein the second set of one or more external devices is different from the first set of one or more external devices, and wherein the second set of one or more criteria is different from the first set of one or more criteria. In some embodiments, the computer system changes the state of the second set of one or more external devices through a network of devices (e.g., the computer system requests an accessory management application and/or another device to alter the state of the second set of one or more external devices). In some embodiments, the second set of one or more external devices includes the external device that sent the emergency condition. In some embodiments, the second set of one or more external devices are separate from the external device that sent the emergency condition. In some embodiments, the second set of one or more devices are not proximate to the emergency condition (e.g., turning on a TV in a living room and/or lights in a bedroom to simulate occupancy).

In some embodiments, the emergency condition is detected within a physical environment (e.g., 802, 804, 806, 808, 810, 812, and/or 880) (e.g., within a home, near a home, in and/or around a monitored area, and/or within a secure area) including the computer system. In some embodiments, the first set of one or more external devices and/or the second set of one or more external devices are assigned to the physical environment and/or are configured into an ecosystem of devices within the physical environment (e.g., a home management ecosystem and/or a home security system).

In some embodiments, the physical environment includes a first zone (e.g., 802) and a second zone (e.g., 804) different from the first zone. In some embodiments, the first set of one or more external devices are assigned to (and/or located within) the first zone. In some embodiments, the second set of one or more external devices are assigned to (and/or located within) the second zone. In some embodiments, the first set of one or more criteria includes a criterion that is satisfied when the emergency condition is determined to correspond to the first zone (e.g., as discussed above with respect to FIG. 8F) (e.g., and not the second zone). In some embodiments, the second set of one or more criteria includes a criterion that is satisfied when the emergency condition is determined to correspond to the second zone (e.g., as discussed above with respect to FIG. 8C) (e.g., and not the first zone). In some embodiments, the first zone and/or the second zone are physical spaces within the physical environment and/or assigned locations within the physical environment. In some embodiments, the first zone and/or the second zone are monitored areas within the physical environment and/or areas within the physical environment that include one or more devices. In some embodiments, the second zone is a secure zone and/or armed zone (e.g., devices alert in response to detecting activity within the zone and/or device monitoring includes alerting and/or other higher security functionality). In some embodiments, the second zone is a category of location that has an increased level of response (e.g., within a home and/or within a room with a known subject such as a homeowner and/or child).

In some embodiments, the first zone has a first security level (e.g., as discussed above with respect to FIG. 8B). In some embodiments, the second zone has a second security level (e.g., as discussed above with respect to FIG. 8B) greater than the first zone. In some embodiments, the first security level and/or the second security level correspond to whether an emergency condition is triggered when activity and/or an event is triggered (e.g., a person walking through a lower security zone can cause monitoring but not an alarm and/or a person within a high security zone triggers an emergency condition).

In some embodiments, the first zone corresponds to a first room (e.g., as discussed above with respect to FIG. 8A) within the physical environment. In some embodiments, the second zone corresponds to a second room (e.g., as discussed above with respect to FIG. 8A) within the physical environment. In some embodiments, the second room is separate from the first room. In some embodiments, the first room and/or the second room include assigned security levels (e.g., a living room has a different security level than a bedroom and/or a garage has a different security level than a child’s room).

In some embodiments, the first zone corresponds to a first virtual boundary (e.g., as discussed above with respect to FIG. 8A) designated within the physical environment. In some embodiments, the second zone corresponds to a second virtual boundary (e.g., as discussed above with respect to FIG. 8A) designated within the physical environment. In some embodiments, the second virtual boundary is different from the first virtual boundary. In some embodiments, the first virtual boundary and/or the second virtual boundary are defined by a user and/or automatically defined based on the physical environment (e.g., can be modified and/or altered by a user). In some embodiments, a user designates the first virtual boundary and/or the second virtual boundary by assigning premade and/or generated localities within the physical environment attributes such as borders, a security level, and/or an identifier (e.g., bedroom and/or living room) and/or by mapping localities by assigning dimensions of a desired zone.

In some embodiments, detecting the emergency condition includes detecting, via one or more cameras (e.g., as discussed above with respect to FIG. 8B) (e.g., of the computer system and/or of a device external to the computer system), the emergency condition. In some embodiments, the one or more cameras are external to the computer system (e.g., one or more accessory devices with cameras that communicate with the computer system and/or the computer system receives alerts and/or information from the one or more accessory devices). In some embodiments, the one or more cameras are part of the computer system. In some embodiments, the one or more cameras are included in the first set of one or more external devices and/or the second set of one or more external devices (e.g., changing a state of the one or more cameras in response to detecting the emergency condition, such as engaging recognition, monitoring, and/or providing a visual indication of the one or more cameras activity).

In some embodiments, detecting the emergency condition includes recognizing (e.g., as discussed above with respect to FIG. 8B), via the one or more cameras (e.g., of the computer system and/or of a device external to the computer system), a subject (e.g., 830 and/or 832) (e.g., a face and/or object) corresponding to (e.g., associated with and/or that triggered) the emergency condition. In some embodiments, recognizing includes determining whether the subject is a known and/or unknown subject (e.g., whether the subject corresponding to the activity that triggered the emergency condition is a member of a household of users or is a designated guest and/or whether the subject detected is unknown). In some embodiments, the first set of one or more criteria includes a criterion that is satisfied when the subject recognized through the one or more cameras is an unknown subject.

In some embodiments, detecting the emergency condition includes detecting, via one or more microphones (e.g., as discussed above with respect to FIG. 8B) (e.g., of the computer system and/or of a device external to the computer system), the emergency condition. In some embodiments, the one or more microphones are external to the computer system (e.g., one or more accessory devices with cameras that communicate with the computer system and/or the computer system receives alerts and/or information from the one or more accessory devices). In some embodiments, the one or more microphones are part of the computer system. In some embodiments, the one or more microphones are included in the first set of one or more external devices and/or the second set of one or more external devices (e.g., changing a state of the one or more microphones in response to detecting the emergency condition, such as engaging recognition, monitoring, and/or providing a visual indication of the one or more microphones activity).

In some embodiments, detecting the emergency condition includes recognizing (e.g., as discussed above with respect to FIG. 8B), via the one or more microphones, a subject (e.g., 830 and/or 832) (e.g., a voice, an event, and/or a sound) corresponding (e.g., associated with and/or that triggered) to the emergency condition. In some embodiments, recognizing the subject corresponding to the emergency condition includes recognizing a person’s voice that is involved in the emergency condition, recognizing an event and/or sound that triggered and/or is part of the emergency condition (e.g., glass breaking, door banging, gate opening, and/or person crying out).

In some embodiments, detecting the emergency condition includes detecting (e.g., via one or more input devices of the computer system and/or of via one or more input devices a device external to the computer system) an unknown person (e.g., 830 and/or 832). In some embodiments, an unknown person is an unrecognized person, a person that does not belong to a household and/or group of known users (e.g., a group of users permitted within an environment and/or within a secure area), a person that has not been validated by a known person and/or user before being detected, and/or a person that lacks an account and/or profile connected to the computer system (e.g., a person that has not been previously recognized and/or detected by the computer system).

In some embodiments, detecting the emergency condition includes detecting (e.g., via one or more input devices of the computer system and/or of via one or more input devices a device external to the computer system) breaking of glass (e.g., as discussed above with respect to FIG. 8D). In some embodiments, detecting the breaking of glass includes the computer system detecting a sound and, in response, recognizing that the sound is associated with the breaking of glass. In some embodiments, after recognizing the sound is associated with the breaking of glass, the computer system triggers an emergency condition corresponding to the broken glass.

In some embodiments, changing the state of the first set of one or more external devices includes displaying, via an external device of the first set of one or more external devices, visual content (e.g., as discussed above with respect to FIGS. 8C and/or 8D). In some embodiments, the computer system displays the visual content to create an illusion of occupancy within a room that the external device is located (e.g., turning on and/or displaying a video on a TV to create an illusion that people are watching TV). In some embodiments, more than one external devices within the first set of one or more external devices displays the visual content (e.g., increasing preserved activity be activating the visual content on more than one external device).

In some embodiments, changing the state of the first set of one or more external devices includes outputting, via an external device of the first set of one or more external devices, audio content (e.g., as discussed above with respect to FIGS. 8C and/or 8D). In some embodiments, the audio content is music and/or audiovisual content (e.g., audio from a TV show and/or movie). In some embodiments, the computer system outputs the audio content to create the illusion of occupancy (e.g., outputting audio of a TV show to create an illusion that people are watching TV and/or outputting imitation content such as a fake party, dialog of two people, and/or people yelling). In some embodiments, more than one external devices within the first set of one or more external devices outputs the audio content (e.g., increasing preserved activity be activating the audio content on more than one external device).

In some embodiments, changing the state of the first set of one or more external devices includes changing a power state (e.g., as discussed above with respect to FIGS. 8C and/or 8D) of an accessory device of the first set of one or more external devices. In some embodiments, changing the power state of the accessory device includes turning on an inactive device and/or turning off an active device. In some embodiments, changing the power state of the accessory device includes performing one or more default actions (e.g., a TV playing default content in response to being turned on by an emergency condition and/or a speaker playing audio in response to being turned on by an emergency condition).

In some embodiments, the emergency condition is a first emergency condition (e.g., as discussed above with respect to FIG. 8C). In some embodiments, after changing the state of the first set of one or more external devices, the computer system detects a second emergency condition (e.g., as discussed above with respect to FIG. 8D) (and/or detecting, at a second time, the first emergency condition and/or continuing to detect the first emergency condition) different from the first emergency condition. In some embodiments, in response to detecting the second emergency condition, the computer system changes a state of a third set of one or more external devices (e.g., 806a and 806b, 808a-808f, 810a-810c, and/or 812a-812c) different from the first set of one or more external devices. In some embodiments, the third set of one or more external devices includes the first set of one or more external devices and at least one other external device (and/or another set of external devices). In some embodiments, the third set of one or more external devices is the second set of one or more external devices. In some embodiments, the third set of one or more external devices includes the second set of one or more external devices and at least one other external device (and/or another set of external devices). In some embodiments, the third set of one or more external devices includes the first set of one or more external devices and the second set of one or more external devices.

In some embodiments, the emergency condition is a first emergency condition (e.g., as discussed above with respect to FIG. 8C). In some embodiments, the state of the first set of one or more external devices is a first state (e.g., as discussed above with respect to FIG. 8C) of the first set of one or more external devices (e.g., 806a and 806b, 808a-808f, 810a-810c, and/or 812a-812c). In some embodiments, after changing the state of the first set of one or more external devices, the computer system detects a second emergency condition (e.g., as discussed above with respect to FIG. 8D) (and/or detecting, at a second time, the first emergency condition and/or continuing to detect the first emergency condition) different from the first emergency condition. In some embodiments, in response to detecting the second emergency condition, the computer system changes a second state (e.g., as discussed above with respect to FIG. 8D) of the first set of one or more external devices, wherein the second state of the first set of one or more external devices is different from the first state of the first set of one or more external devices. In some embodiments, the second state of the first set of one or more external devices is an elevated state of the first state of the first set of one or more external devices (e.g., an elevation of current output volume and/or an increase in intensity of video content). In some embodiments, the second state of the first set of one or more external devices is an alteration of the first state of the first set of one or more external devices (e.g., a change in audio content and/or an addition of other audio output).

In some embodiments, before detecting the emergency condition, the computer system arms a set of one or more monitoring devices (e.g., as discussed above with respect to FIG. 6A) external to the computer system, wherein the first set of one or more criteria includes a criterion that is satisfied when the set of one or more monitoring devices are armed (e.g., as discussed above with respect to FIG. 6A). In some embodiments, the set of one or more monitoring devices includes and/or is part of the first set of one or more external devices and/or the second set of one or more external devices. In some embodiments, while the set of one or more monitoring devices are armed, the set of monitoring devices trigger and/or alert the computer system of activity and/or events detected. In some embodiments, detecting the emergency condition includes receiving an alert from a device of the set of one or more monitoring devices.

Note that details of the processes described above with respect to process 900 (e.g., FIG. 9) are also applicable in an analogous manner to other processes described herein. For example, process 1100 optionally includes one or more of the characteristics of the various processes described above with reference to process 900. For example, the activity of process 1100 can include the emergency condition of process 900. For brevity, these details are not repeated herein.

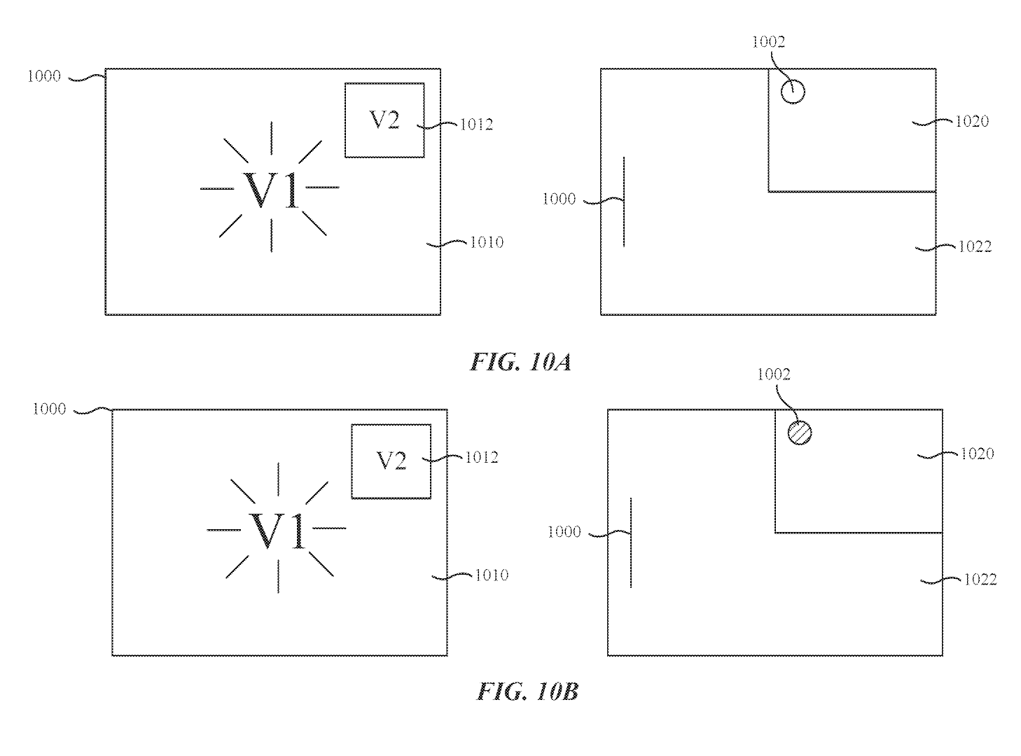

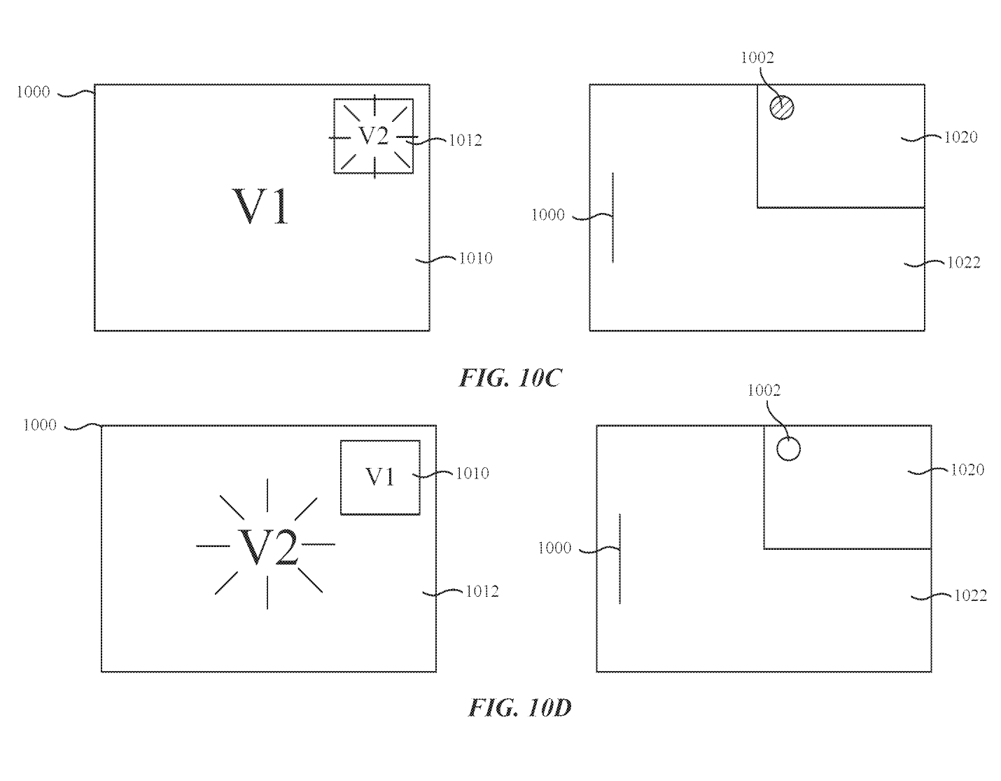

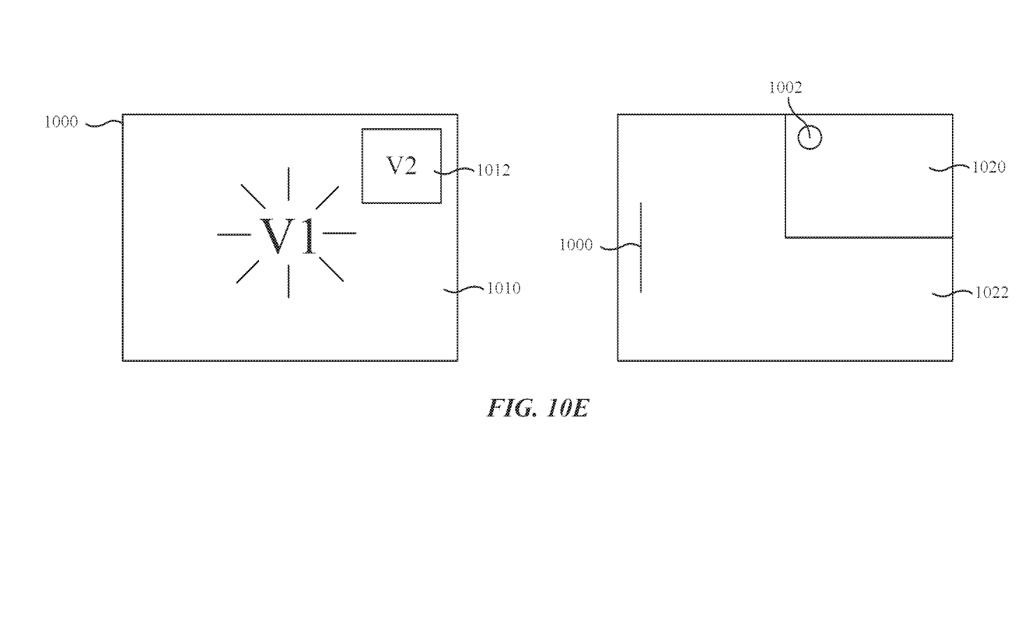

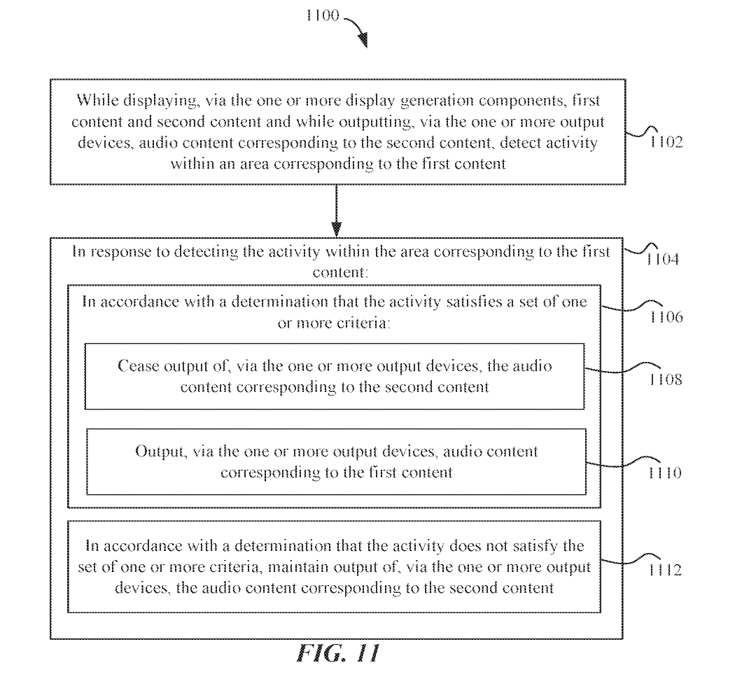

FIGS. 10A-10E illustrates exemplary user interfaces for outputting content based on detected activity in accordance with some embodiments. The user interfaces in these figures are used to illustrate the processes described below, including the processes in FIG. 11.

FIGS. 10A-10E include a left portion, which illustrates device 1000 outputting content, and a right portion, which illustrates an environment that includes device 1000 and device 1002. As illustrated in the left portion of FIGS. 10A-10E, device 1000 displays two portions of content (e.g., content 1010 and content 1012) and outputs audio corresponding to one of the portions of content. Further, as illustrated in the right portion of FIGS. 10A-10E, the environment is split between two separate rooms (e.g., room 1020 and room 1022) in which device 1000 is positioned within room 1022 and device 1002 is positioned within room 1020. In some embodiments, room 1020 and room 1022 are physically separate rooms. For example, room 1020 is a living room of a home and room 1022 is a bedroom and/or baby room within the home.

At FIGS. 10A-10E, device 1002 is a device that monitors room 1020. In some embodiments, device 1002 includes (and/or is) a camera positioned within room 1020 and monitors room 1020 through a field of view of the camera. In some embodiments, device 1002 includes one or more microphones and monitors room 1020 for certain audio patterns and/or noises through the one or more microphones. For example, as discussed further below, device 1002 can monitor for a baby crying and/or choking within room 1020. In this example, device 1002 is positioned to monitor a baby within room 1020 (e.g., a baby sleeping within room 1020 while parents are watching content on device 1000 within room 1022). It should be recognized that while the following examples are within a home context and/or within a baby monitoring context, device 1002 can be configured to monitor other activities. For example, device 1002 can be positioned outside of a building and/or home to monitor an entry way for clients and/or guests. In some embodiments, device 1002 is a device of the set of accessory devices discussed above with respect to FIG. 3 (e.g., included within an ecosystem of devices for a home that includes room 1020 and room 1022).

As illustrated in FIG. 10A-10E, device 1000 is a computer system positioned within room 1022. In some embodiments, device 1000 includes a display. For example, device 1000 can be a TV and/or is a computer system in communication with a display positioned within room 1022. In some embodiments, device 1000 is a resident device as discussed above with respect to FIG. 3. For example, device 1000 can manage and/or communicate with one or more accessory devices (e.g., device 1002) within a home (e.g., home 880 in FIGS. 8A-8F) that includes room 1020 and room 1022. As illustrated in FIG. 10A-10E, device 1000 displays content 1012 within and/or overlapping content 1010. In some embodiments, device 1000 displays content 1012 alongside and/or with content 1010. For example, device 1000 can display content 1012 and content 1010 next to each other to not obstruct a portion of either content 1012 or content 1010. In this embodiment, content 1010 is media content. For example, content 1010 can be streaming content such as live TV and/or remotely stored TV shows and/or movies. For another example, content 1010 can be locally stored audiovisual content such as saved home videos, locally stored TV shows, and/or downloaded movies. In this embodiment, content 1012 is a live video stream received from device 1002. For example, content 1012 is a live video feed of a baby’s room (e.g., room 1020) sent by device 1002 to device 1000 (e.g., through the ecosystem of devices and/or a home network).

As illustrated in FIG. 10A, device 1002 is inactive and/or does not detect an activity within room 1020 (e.g., as indicated by a lack of shading of device 1002 in FIG. 10A as compared to 10B). For example, device 1002 is inactive because a baby within room 1020 is sleeping quietly and/or there is nothing within room 1020 that requires intervention by a user. In some embodiments, device 1002 is inactive due to not detecting activity within a threshold amount of time. For example, device 1002 is inactive in response to a previously detected event being remedied and/or no longer detected.

As illustrated in FIG. 10A, in response to device 1002 not detecting activity within room 1020, device 1000 outputs audio content corresponding to content 1010 and does not output audio content corresponding to content 1012. Further, as illustrated in FIG. 10A, device 1000 displays content 1012 at a reduced size as compared to content 1010. Notably, device 1000 provides both content for viewing (e.g., so parents can enjoy a TV show and monitor their sleeping baby) but emphasizes content 1010 in response to device 1002 not detecting activity within room 1020. In some embodiments, device 1000 displays content 1012 with reduced visual clarity and/or visual characteristics to emphasize content 1010. For example, device 1000 can reduce the opacity of content 1012, allowing users to view content 1012 but also see the portion of content 1010 covered by content 1012. As discussed further below, device 1000 can swap the audio content between content 1012 and content 1010 depending on criteria corresponding to device 1002. For example, device 1000 outputs the audio content corresponding to content 1012 in response to device 1002 detecting activity within room 1020.

At FIG. 10B, while displaying content 1010 prominently (e.g., content 1012 at a reduced size within content 1010) and outputting the audio content corresponding to content 1010, device 1002 detects activity within room 1020 (e.g., as indicated by the shading of device 1002 in FIG. 10B). In some embodiments, device 1000 detects the activity by receiving from device 1002 an alert and/or indication of the activity within room 1020. For example, device 1002 can send an indication of the activity through the ecosystem of devices and/or directly to device 1000. In some embodiments, an activity includes activity over a predefined threshold. For example, the predefined threshold can correspond to movement over a threshold (e.g., a baby squirming and/or wiggling within a crib of a certain severity), crying over a threshold, and/or distance of movement (e.g., movement of a baby beyond a proximity to a point within room 1020). In some embodiments, an activity includes one or more preloaded criteria that device 1002 monitors. For example, device 1000 can monitor for activity of a certain level, activity that includes a person, activity that includes an object of a threshold size, and/or activity detected for a certain amount of time. In some embodiments, an activity includes one or more user defined activities that device 1002 is programed to monitor. For example, the one or more user defined activities to monitor can include a baby crying, a baby choking, a baby climbing over a crib, a baby moving over a certain amount, and/or another person within the room with a baby.

In some embodiments, while detecting the activity within room 1020, an activity severity is assigned to the activity. For example, device 1000 can assign and/or recognize the severity to the activity after receiving information about the activity from device 1002. In some embodiments, device 1002 assigns a severity to the activity before alerting and/or sending information to device 1000. In some embodiments, device 1000 uses a large language model (e.g. LLM) to recognize the severity of the activity. For example, device 1000 can provide the LLM a portion of the live feed (e.g., a clip captured by device 1002 and/or saved by device 1000 from the live video feed of device 1002) to determine the severity of the activity. For another example, device 1000 can provide the LLM characteristics and/or heuristic information (e.g., based on a portion of the live feed that corresponds to the activity) to determine the severity of the activity. In some embodiments, the LLM adjusts the threshold values associated with the recognized level of severity associated with the activities. For example, the LLM can provide device 1000 updated threshold values and/or parameters based on the activity within room 1020 (e.g., raising a based threshold due to continuing to detect small amounts of activity and/or reducing a threshold based on not detecting activity that should be detected).

As illustrated in FIG. 10C, in response to device 1002 detecting the activity within room 1020, device 1000 outputs audio content corresponding to content 1012 and ceases output of the audio content corresponding to content 1010. Also illustrated in FIG. 10C, while device 1000 has swapped the outputted audio content, device 1000 maintains display of content 1012 within and/or overlapping content 1010. As illustrated in FIG. 10C, device 1000 also maintains the visual characteristics of content 1010 and content 1012 (e.g., not changing size or modifying the content). In some embodiments, device 1000 reverts content 1012 in response to outputting the audio content corresponding to content 1012. For example, device 1000 can revert content 1012 by increasing its opacity from a reduced level (e.g., as discussed above to provide visibility of content 1010) to a full level (e.g., providing increased visual clarity and blocking content 1010).

In some embodiments, after a threshold amount of time and/or in response to determining that the activity is no longer detected, device 1000 ceases output of the audio content corresponding to content 1012 and outputs the audio content corresponding to content 1010. For example, device 1000 can swap the output of the audio content in response to device 1002 no longer detecting a baby crying within room 1020. For another example, device 1000 can swap the output of the audio content in response to device 1002 detecting that the activity has been remedied and/or addressed (e.g., parents are able to stop a baby’s crying and/or parents pick up a baby from a crib within room 1020). In some embodiments, device 1000 performs a determination on whether to swap the audio content before swapping the audio content (and/or whether to swap the audio content back). For example, device 1000 only swaps the audio content and/or swaps the displayed content if the severity is over a certain threshold as discussed above. In some embodiment, device 1000 uses the LLM to determine whether the activity warrants swapping of the audio content (and/or swapping of the audio content back).

While outputting the audio content corresponding to content 1012, device 1002 continues to detect the activity within room 1020 (e.g., for a threshold amount of time). In some embodiments, device 1002 detects an escalation of the activity within room 1020 and/or new activity of a higher severity within room 1020. For example, device 1002 detects that a crying baby begins to choke and/or begins to climb out of the baby’s crib.

In some embodiments, device 1000 can maintain display of the content (e.g., without swapping) in response to continuing to detect the activity for under the threshold amount of time (e.g., providing time to see if the activity stops and/or does not require intervention). For example, device 1000 does not immediately swap content 1010 and content 1012 to provide time to see whether a baby within room 1020 will stop crying without intervention by the baby’s parents.

As illustrated in FIG. 10D, in response to device 1002 continuing to detect the activity within room 1020 (and/or detecting an escalation of the activity within room 1020), device 1000 swaps content 1010 and content 1012. In some embodiments, device 1000 swaps the content to provide a further indication of the activity within room 1020. As illustrated in FIG. 10D, device 1000 swapping content 1010 and content 1012 includes reducing the size of content 1010 and displaying content 1010 within content 1012 that has been increased in size. In some embodiments, device 1000 swapping content 1010 and content 1012 includes altering visual characteristics of content 1010 and/or content 1012. For example, as discussed above, device 1000 can revert content 1012 to its default visual characteristics (e.g., without decreased capacity) and/or device 1000 can reduce the opacity of content 1010 to provide users the ability to see content 1012 through content 1010.

In some embodiments, device 1000 immediately swaps content and audio in response to device 1002 detecting an activity with a certain heightened level (e.g., not requiring duration and/or escalation). For example, device 1000 immediately swaps the content and the audio in response to device 1002 detecting that a baby is choking within room 1020 (e.g., activity that requires immediate attention and/or intervention). For another example, device 1000 immediately swaps the content and the audio in response to device 1002 detecting that an intruder is within a room of a home (e.g., as discussed above with respect to FIGS. 8A-8F).

In some embodiments, in response to device 1000 swapping content 1010 and content 1012 (e.g., signifying an escalation of the activity within room 1020), device 1000 alters a state of one or more other devices (e.g., as discussed above with respect to FIGS. 8A-8F). For example, device 1000 can turn on one or more lights within room 1022 (and/or another room that includes occupants and/or people that can address the activity within room 1020) to provide an additional alert of the activity within room 1020. In some embodiments, as part of swapping the content, device 1000 provides a visual indication and/or alters a visual characteristic of content 1012. For example, device 1000 can display a notification and/or indication of the activity within and/or overlapping content 1012. For another example, device 1000 can provide a colored hue and/or visual indication through content 1012 to provide an indication of the severity. In some embodiments, as part of swapping the content, device 1000 escalates the audio content corresponding to content 1012. For example, device 1000 can increase a volume level of the audio content corresponding to content 1012. In some embodiments, after swapping the content, device 1000 outputs an audible description of the activity and/or an alert of the activity. For example, device 1000 can use the LLM to generate a description of the activity within room 1020 and, after receiving the description from the LLM, device 1000 outputs a dictation of the description. For another example, device 1000 can output an audible alert corresponding to the activity, such as outputting an identification of room 1020, an identification of device 1002, and/or an identifier of the activity to provide occupants with additional information about the activity.

At FIG. 10D, after swapping the content, device 1002 no longer detects the activity. In some embodiments, device 1002 no longer detects the activity includes detecting that the activity has been addressed. For example, device 1000 can receive an indication from device 1002 that a parent has checked on and/or addressed a crying baby.

As illustrated in FIG. 10E, in response to device 1002 no longer detecting the activity within room 1020, device 1000 reverts the displayed content and outputted audio. As illustrated in FIG. 10E, reverting the displayed content includes device 1000 displaying content 1010 prominently (e.g., at content 1010’s original size and visual characteristics) and displaying content 1012 at the reduced size overlapping content 1010 (e.g., with and/or without altered visual characteristics as discussed above). Further, as illustrated in FIG. 10E, reverting the outputted audio includes device 1000 ceasing output of the audio content corresponding to content 1012 and outputting the audio content corresponding to content 1010.

FIG. 11 is a flow diagram illustrating a process (e.g., process 1100) for outputting audio based on activity within an area in accordance with some embodiments. Some operations in process 1100 are, optionally, combined, the orders of some operations are, optionally, changed, and some operations are, optionally, omitted.

As described below, process 1100 provides an intuitive way for outputting audio based on activity within an area. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a computer system (e.g., 1000) that is in communication with one or more output devices (e.g., as discussed above with respect to FIG. 10A) (e.g., a display generation component, an audio generation component, and/or a haptic generation component) and one or more display generation components (e.g., as discussed above with respect to FIG. 10A) (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, an electronic device, and/or a personal computing device.

While displaying, via the one or more display generation components, first content (e.g., 1012) (e.g., a live video feed and/or PIP of another area) and second content (e.g., 1010) (e.g., video content and/or streaming content) and while outputting, via the one or more output devices, audio content (e.g., as discussed above with respect to FIG. 10A) corresponding to (e.g., from and/or associated with) the second content, the computer system detects (1102) activity within an area (e.g., 1020) (e.g., a bedroom and/or second area with the home) corresponding to the first content. In some embodiments, the first content includes a live feed from one or more cameras included within, external to, separate from, and/or different from the computer system. In some embodiments, the activity is a change within the area that is sensitive and/or activity that needs monitoring (e.g., a baby sleeping and/or children playing). In some embodiments, the activity corresponds to a potential emergency and/or situation that could require attention. In some embodiments, the area is part of a home and/or an environment including the computer system. In some embodiments, the area is a monitored area and/or an area assigned a certain importance level.

In response to (1104) detecting the activity within the area corresponding to the first content, in accordance with (1106) a determination that the activity satisfies a set of one or more criteria, the computer system ceases (1108) output of, via the one or more output devices, the audio content corresponding to the second content. In some embodiments, the computer system continues display of the second content (e.g., does not pause and/or interrupt display of the second content). In some embodiments, the activity within the second area satisfies the set of one or more criteria when the activity is over a predefined threshold (e.g., a baby crying for a certain amount of time and/or at a certain level) and/or matches a predefined alert event (e.g., a baby no longer breathing and/or a baby choking).

In response to (1104) detecting the activity within the area corresponding to the first content, in accordance with (1106) the determination that the activity satisfies the set of one or more criteria, the computer system outputs (1110), via the one or more output devices, audio content corresponding to (e.g., associated with and/or from) the first content (e.g., as discussed above with respect to FIG. 10C). In some embodiments, the computer system continues display of the first content and/or the second content.

In response to (1104) detecting the activity within the area corresponding to the first content, in accordance with a determination that the activity does not satisfy the set of one or more criteria, the computer system maintains (1112) output of, via the one or more output devices, the audio content corresponding to the second content (e.g., without outputting the audio content corresponding to the first content). In some embodiments, in response to detecting the activity within the area corresponding to the first content and in accordance with the determination that the activity does not satisfy the set of one or more criteria, the computer system maintains display of the first content and/or the second content. In some embodiments, in response to detecting the activity within the area corresponding to the first content and in accordance with the determination that the activity does not satisfy the set of one or more criteria, the computer system increases a size of the first content (e.g., to draw attention to the first content but not to fully interrupt the second content) without switching audio output.

In some embodiments, the area is a first area (e.g., 1020). In some embodiments, the computer system is located in a second area (e.g., 1022) (e.g., a room, a zone, and/or a boundary) separate (and/or different) from the first area. In some embodiments, the first area and the second area are physically separate (e.g., separate rooms within a home and/or distant areas within an environment). In some embodiments, the first area and the second area are separate virtually defined zones (e.g., defined by the computer system based on an environment and/or configured by a user).

In some embodiments, detecting the activity within the area corresponding to the first content includes detecting, via one or more cameras of another computer system (e.g., 1002) separate from the computer system, the activity within the area corresponding to the first content. In some embodiments, the other computer system is an accessory device (e.g., a remote camera device and/or network connected camera). In some embodiments, the computer system receives, from the other computer system, information (e.g., an alert, a video stream, image recognition information, and/or environmental information) corresponding to the activity within the area corresponding to the activity (e.g., and does not receive content captured via the other computer system, such as an image, an audio recording, and/or a video).

In some embodiments, after ceasing output of the audio content corresponding to the second content and while outputting the audio content of the first content, the computer system detects that a threshold amount of time (e.g., as discussed above with respect to FIG. 10B) has passed since detecting the activity within the area corresponding to the first content (e.g., not detecting another activity within the area within the threshold amount of time and/or not detecting an increase in the activity within the threshold amount of time). In some embodiments, detecting that the threshold amount of time has passed since detecting the activity within the area corresponding to the first content includes assigning a time value to an end of the activity (e.g., a baby stops crying and/or an event ends). In some embodiments, in response to detecting that the threshold amount of time has passed since detecting the activity within the area corresponding to the first content, the computer system ceases output of, via the one or more output devices, the audio content corresponding to the first content. In some embodiments, in response to detecting that the threshold amount of time has passed since detecting the activity within the area corresponding to the first content, the computer system outputs, via the one or more output devices, the audio content corresponding to the second content. In some embodiments, outputting the audio content corresponding to the second content includes outputting the audio content corresponding to the second content at an initial volume level before the audio content was ceased and/or a set volume level.

In some embodiments, before detecting the activity within the area corresponding to the first content, the first content is displayed within the second content (e.g., displaying the first content as a picture-in-picture inside of the second content and/or displaying the first content at a reduced size on top of the second content). In some embodiments, displaying the first content within the second content includes displaying the first content at a first size and the second content at a second size that is greater than the first size. In some embodiments, after ceasing output of the audio content corresponding to the second content and while outputting the audio content of the first content, the computer system detects the activity within the area corresponding to the first content for a threshold amount of time (e.g., as discussed above with respect to FIG. 10B) (and/or continuing to detect the activity within the area corresponding to the first content for greater than a threshold amount of time). In some embodiments, detecting the activity within the area corresponding to the first content for the threshold amount of time includes detecting a continuation of the activity (e.g., a baby continues to cry and/or an event continues), detecting an elevation of the activity (e.g., baby starts choking and/or screaming after crying), and/or detecting additional activity within the area. In some embodiments, in response to detecting the activity within the area corresponding to the first content for the threshold amount of time, the computer system displays, via the one or more display generation components, the second content within the first content (e.g., as discussed above with respect to FIG. 10C) (e.g., displays the second content as a picture-in-picture inside of the first content and/or displays the second content at a reduced size on top of the first content). In some embodiments, displaying the second content within the first content includes displaying the first content at the second size and the second content at the first size. In some embodiments, in response to detecting the activity within the area corresponding to the first content for the threshold amount of time, the computer system swaps the first content and the second content (e.g., displays the second content within the first content).

In some embodiments, in response to detecting the activity within the area corresponding to the first content for the threshold amount of time, the computer system increases, via the one or more output devices, a volume level of the first content (e.g., as discussed above with respect to FIG. 10D) (and/or outputs, via the one or more output devices, the audio content corresponding to the first content at an increased level and/or with one or more altered audio characteristics as compared to before detecting the activity within the area corresponding to the first content for the threshold amount of time).

In some embodiments, displaying the first content and the second content includes displaying, via the one or more display generation components, the first content overlapping the second content (e.g., as discussed above with respect to FIG. 10A) (e.g., displaying the first content at a reduced size on top of the second content and/or displaying the first content as a picture-in-picture within the second content). In some embodiments, the computer system positions the first content on top of the second content at a position as to not impede the viewing of the second content (e.g., in a corner of the second content outside of a movie scene and/or within a portion of the second content that has a reduced visual interest).

In some embodiments, the set of one or more criteria includes a criterion that is satisfied when a level of activity corresponding to the activity (and/or a characteristic of the activity) exceeds a threshold activity level (e.g., as discussed above with respect to FIG. 10D). In some embodiments, while (and/or after) detecting the activity within the area corresponding to the first content, the computer system recognizes a characteristic of the activity (e.g., recognizes an intensity of movement and/or activity such as a level of baby crying and/or level of distress of a baby). In some embodiments, the criterion that is satisfied when the level of activity corresponding to the activity exceeds the threshold activity level is based on detecting the level of activity corresponding to the activity and/or assigning the level of activity based on a characteristic of the activity (and/or recognized level of activity). In some embodiments, the threshold activity level is established by the computer system and/or is defined by a profile and/or user setting. In some embodiments, the threshold activity level changes depending on an area and/or depending on a base line activity level (e.g., a base and/or average activity level within the area over time).

In some embodiments, the threshold activity level is a first threshold activity level (e.g., as discussed above with respect to FIG. 10D). In some embodiments, the activity is a first activity (e.g., as discussed above with respect to FIG. 10B). In some embodiments, the set of one or more criteria is a first set of one or more criteria. In some embodiments, while outputting the audio content corresponding to the second content, the computer system displays, via the one or more display generation components, the first content within the second content (e.g., displays the first content as a picture-in-picture inside of the second content and/or displays the first content at a reduced size on top of the second content). In some embodiments, while displaying the first content within the second content and while outputting the audio content corresponding to the second content, the computer system detects second activity (e.g., as discussed above with respect to FIG. 10C) within the area corresponding to the first content. In some embodiments, the second activity is a change within the area that is sensitive and/or activity that needs monitoring (e.g., a baby sleeping and/or children playing). In some embodiments, the second activity corresponds to a potential emergency and/or situation that could require attention. In some embodiments, in response to detecting the second activity within the area corresponding to the first content, in accordance with a determination that the second activity within the area corresponding to the first content satisfies the first set of one or more criteria, the computer system maintains display of the first content within the second content. In some embodiments, in response to detecting the second activity within the area corresponding to the first content, in accordance with the determination that the second activity within the area corresponding to the first content satisfies the first set of one or more criteria, the computer system ceases output of, via the one or more output devices, the audio content corresponding to the second content. In some embodiments, in response to detecting the second activity within the area corresponding to the first content, in accordance with the determination that the second activity within the area corresponding to the first content satisfies the first set of one or more criteria, the computer system outputs, via the one or more output devices, audio content corresponding to (e.g., associated with and/or from) the first content. In some embodiments, the computer system continues display of the first content and/or the second content. In some embodiments, in response to detecting the second activity within the area corresponding to the first content, in accordance with a determination that the second activity within the area corresponding to the first content satisfies a second set of one or more criteria (e.g., as discussed above with respect to FIG. 10D), wherein the second set of one or more criteria includes a criterion that is satisfied when the level of activity is greater than a second threshold activity level, wherein the second threshold activity level is greater than the first threshold activity level, and wherein the second set of one or more criteria is different from the first set of one or more criteria, the computer system displays, via the one or more display generation components, the second content within the first content (e.g., displays the second content as a picture-in-picture inside of the first content and/or displays the second content at a reduced size on top of the first content). In some embodiments, the second threshold activity level is an emergency activity level (e.g., the first threshold activity level corresponds to activity that should be monitored and/or check on and the second threshold activity level corresponds to activity that requires intervention such as a baby choking, an elderly individual falling, and/or other activity that requires a subject to go to the area to help and/or intervene). In some embodiments, in response to detecting the second activity within the area corresponding to the first content, in accordance with the determination that the second activity within the area corresponding to the first content satisfies the second set of one or more criteria, wherein the second set of one or more criteria includes the criterion that is satisfied when the level of activity is greater than the second threshold activity level, wherein the second threshold activity level is greater than the first threshold activity level, and wherein the second set of one or more criteria is different from the first set of one or more criteria, the computer system ceases output of, via the one or more output devices, the audio content corresponding to the second content. In some embodiments, in response to detecting the second activity within the area corresponding to the first content, in accordance with the determination that the second activity within the area corresponding to the first content satisfies the second set of one or more criteria, wherein the second set of one or more criteria includes the criterion that is satisfied when the level of activity is greater than the second threshold activity level, wherein the second threshold activity level is greater than the first threshold activity level, and wherein the second set of one or more criteria is different from the first set of one or more criteria, the computer system outputs, via the one or more output devices, the audio content corresponding to the first content.

In some embodiments, in response to detecting the second activity within the area corresponding to the first content and in accordance with the determination that the second activity within the area corresponding to the first content satisfies the second set of one or more criteria, the computer system displays, via the one or more display generation components, an emergency indication (e.g., as discussed above with respect to FIG. 10D). In some embodiments, the emergency indication includes a user-interface element for drawing attention to the first content, a change in visual characteristic of the first content and/or the second content to draw attention to the second activity (e.g., red hue and/or colored border), and/or an animation to draw attention to the second activity (e.g., movement of the first content and/or movement of a user-interface element). In some embodiments, the emergency indication is a first emergency indication. In some embodiments, in response to detecting the second activity within the area corresponding to the first content and in accordance with the determination that the second activity within the area corresponding to the first content satisfies the first set of one or more criteria, the computer system displays, via the one or more display generation components, a second emergency indication different from the first emergency indication. In some embodiments, the second emergency indication has a different appearance than the first emergency indication. In some embodiments, the second emergency indication is in a different manner than the first emergency indication.

In some embodiments, in response to detecting the second activity within the area corresponding to the first content and in accordance with the determination that the second activity within the area corresponding to the first content satisfies the second set of one or more criteria, the computer system changes a state of one or more external devices (e.g., as discussed above with respect to FIG. 10D) (e.g., as described above with respect to process 900). In some embodiments, changing the state of the one or more external devices includes changing a power state of the one or more external devices (e.g., turning on and/or of a set of external devices such as lights, speakers, displays, and/or accessory devices) and/or performing an action through the one or more external devices (e.g., opening a blind, playing audio through a speaker, and/or providing an alert via the one or more external devices). In some embodiments, in response to detecting the second activity within the area corresponding to the first content and in accordance with the determination that the second activity within the area corresponding to the first content satisfies the first set of one or more criteria, the computer system changes a state of one or more external devices (e.g., the same way or different as in accordance with the determination that the second activity within the area corresponding to the first content satisfies the second set of one or more criteria).

In some embodiments, the set of one or more criteria includes a criterion that is satisfied based on an output of a large language model (LLM) (e.g., as discussed above with respect to FIG. 10B) (and/or a machine learning model). In some embodiments, the computer system includes the LLM. In some embodiments, the computer system is in communication with the LLM, such as via an application and/or a server that provides a communication layer with the LLM (e.g., the computer system provides a prompt and/or activity information to the communication layer and receives, from the communication, determination and/or response generated by the LLM). In some embodiments, the LLM provides an activity score corresponding to the activity within the area corresponding to the first content. In some embodiments, the set of one or more criteria includes a criterion that is satisfied when the activity score is greater than a threshold activity level. In some embodiments, the activity score is a numerical value classifying a level of activity, is a characteristic and/or information about the activity (e.g., information about the severity and/or nature of the activity), and/or opinion on whether the activity within the area rises to activity that requires attention and/or intervention.

In some embodiments, the activity is a first activity (e.g., as discussed above with respect to FIG. 10B) within the area corresponding to the first content. In some embodiments, after maintaining output of the audio content corresponding to the second content in response to detecting the first activity within the area corresponding to the first content, the computer system detects second activity (e.g., as discussed above with respect to FIG. 10C) within the area corresponding to the first content. In some embodiments, the second activity is a change within the area that is sensitive and/or activity that needs monitoring (e.g., a baby sleeping and/or children playing). In some embodiments, the second activity corresponds to a potential emergency and/or situation that could require attention. In some embodiments, in response to detecting the second activity within the area corresponding to the first content and in accordance with a determination that the second activity within the area corresponding to the first content satisfies the set of one or more criteria (e.g., as discussed above with respect to FIG. 10C), wherein the determination that the second activity within the area corresponding to the first content satisfies the set of one or more criteria uses the same LLM as the determination that the first activity within the area corresponding to the first content satisfies the set of one or more criteria, the computer system ceases output of, via the one or more output devices, the audio content corresponding to the second content. In some embodiments, the computer system continues display of the second content (e.g., does not pause and/or interrupt display of the second content). In some embodiments, in response to detecting the second activity within the area corresponding to the first content and in accordance with the determination that the second activity within the area corresponding to the first content satisfies the set of one or more criteria, wherein the determination that the second activity within the area corresponding to the first content satisfies the set of one or more criteria uses the same LLM as the determination that the first activity within the area corresponding to the first content satisfies the set of one or more criteria, the computer system outputs, via the one or more output devices, audio content corresponding to (e.g., associated with and/or from) the first content. In some embodiments, the computer system continues display of the first content and/or the second content. In some embodiments, the LLM provides another threshold activity level different from the threshold activity level in response to detecting the second activity within the area corresponding to the first content. In some embodiments, the second threshold activity level is an updated threshold activity level based on previous activity and/or preference (e.g., the LLM provides a greater threshold activity level due to a base line activity level within the area being greater than expected and/or greater than the threshold activity level). In some embodiments, the LLM provides different threshold activity levels to tune detection of activity (e.g., tailoring the threshold activity level to match a situation and/or needed monitoring).

In some embodiments, in response to detecting the activity within the area corresponding to the first content and in accordance with the determination that the activity satisfies the set of one or more criteria (and/or while ceasing output of the audio content corresponding to the second content and/or while outputting the audio content corresponding to the first content), the computer system outputs (e.g., via the one or more output devices and/or via the one or more display generation components) a description of the activity (e.g., as discussed above with respect to FIG. 10D) (e.g., received from the LLM and/or generated by the LLM). In some embodiments, the computer system receives the description of the activity from the LLM when the computer system receives the activity score. In some embodiments, outputting the description of the activity includes outputting an audible dictation of the description of the activity generated by the LLM and/or received from the LLM (e.g., the LLM model recognizes conditions and/or points of interest within the activity and provides a natural language description of the activity).

Note that details of the processes described above with respect to process 1100 (e.g., FIG. 11) are also applicable in an analogous manner to the processes described herein. For example, process 500 optionally includes one or more of the characteristics of the various processes described herein with reference to process 1100. For example, the accessory device information of process 500 can include the activity of process 1100. For brevity, these details are not repeated herein.

In some embodiments, one or more of processes 500, 700, 900, and 1100 (FIGS. 5, 7, 9, and 11) is performed at a first computer system (as described herein) via a system process (e.g., an operating system process and/or a server system process) that is different from one or more applications executing and/or installed on the first computer system.

In some embodiments, one or more of processes 500, 700, 900, and 1100 (FIGS. 5, 7, 9, and 11) is performed at a first computer system (as described herein) by an application that is different from a system process.

In some embodiments, the instructions of the application, when executed, control the first computer system to perform one or more of processes 500, 700, 900, and 1100 (FIGS. 5, 7, 9, and 11) by calling an application programming interface (API) provided by the system process. In some embodiments, the application performs at least a portion of one or more of processes 500, 700, 900, and 1100 (FIGS. 5, 7, 9, and 11) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 500, 700, 900, and 1100 (FIGS. 5, 7, 9, and 11) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 500, 700, 900, and 1100 (FIGS. 5, 7, 9, and 11) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 500, 700, 900, and 1100 (FIGS. 5, 7, 9, and 11).

In some embodiments, API 176 defines a first API call response that can be provided to an application by API calling instructions 174, wherein the first API call response includes parameters described above with respect to processes 500, 700, 900, and 1100 (FIGS. 5, 7, 9, and 11).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device responds to events within an environment. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device responds to events within an environment. Accordingly, use of such personal information data enables better user experiences. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, accessory devices can be altered by inferring location based on non-personal information data or a bare minimum amount of personal information, such as the content being requested by the device associated with a user or other non-personal information.

What is claimed is:

1. A method, comprising:
at a computer system that is in communication with one or more input devices and one or more display generation components:
detecting, via the one or more input devices, a first subject within an area;
while detecting the first subject within the area, displaying, via the one or more display generation components, content corresponding to the first subject;
while displaying the content corresponding to the first subject, detecting, via the one or more input devices, a second subject within the area, wherein the second subject is different from the first subject; and
in response to detecting the second subject within the area and while maintaining display of the content corresponding to the first subject, enabling, using a credential for the second subject, a service.

2. The method of claim 1, wherein the one or more input devices include one or more cameras, wherein detecting the first subject includes detecting, via the one or more cameras, a first person, wherein detecting the second subject includes detecting, via the one or more cameras, a second person, and wherein the second person is different from the first person.

3. The method of claim 1, wherein detecting the first subject includes detecting, via a wireless communication channel, a first device, wherein detecting the second subject includes detecting, via a wireless communication channel, a second device, and wherein the second device is different from the first device.

4. The method of claim 3, further comprising:
after detecting the second subject and before enabling the service, displaying, via one or more display generation components of the second device, a confirmation, wherein the second device provides the computer system the credential in response to detecting an input corresponding to the confirmation.

5. The method of claim 1, further comprising:
after displaying the content corresponding to the first subject, detecting, via the one or more input devices, a lack of the first subject within the area; and
in response to detecting the lack of the first subject within the area, ceasing display of, via the one or more display generation components, the content corresponding to the first subject.

6. The method of claim 5, further comprising:
in response to detecting the lack of the first subject within the area, disabling a service that uses a credential of the first subject.

7. The method of claim 1, wherein, while displaying the content corresponding to the first subject, the first subject is a primary subject, the method further comprising:
while detecting the first subject and the second subject and in accordance with a determination that the second subject is the primary subject:
ceasing display of, via the one or more display generation components, content corresponding to the first subject; and
displaying, via the one or more display generation components, content corresponding to the second subject.

8. The method of claim 7, further comprising:
while detecting the first subject and the second subject and in accordance with a determination that the second subject is the primary subject:
forgoing use of one or more device settings corresponding to the first subject; and
using one or more device settings corresponding to the second subject.

9. The method of claim 1, further comprising:
after enabling the service, detecting, via the one or more input devices, a lack of the second subject within the area; and
in response to detecting the lack of the second subject within the area, disabling access to the service.

10. The method of claim 9, further comprising:
in response to detecting the lack of the second subject within the area, removing data corresponding to the second subject.

11. The method of claim 1, further comprising:
after enabling the service, detecting, via the one or more input devices, a lack of the second subject within the area; and
in response to detecting the lack of the second subject within the area, displaying, via one or more display generation components of a device corresponding to the second subject, a prompt for maintaining access to the service.

12. The method of claim 1, further comprising:
after enabling the service, detecting, via the one or more input devices, a third subject within the area, wherein the third subject is different from the first subject and the second subject; and
in response to detecting the third subject within the area, enabling, via a credential of the third subject, another service different from the service.

13. The method of claims claim 1, further comprising:
after enabling the service, detecting, via the one or more input devices, a fourth subject within the area, wherein the fourth subject is different from the first subject and the second subject; and
in response to detecting the fourth subject within the area, forgoing enabling, via a credential of the fourth subject, a service.

14. The method of claim 1, further comprising:
after enabling the service, detecting, via the one or more input devices, a fifth subject within the area, wherein the fifth subject is different from the first subject and the second subject; and
in response to detecting the fifth subject within the area, updating, via a credential of the fifth subject, the credential enabling the service to the credential of the fifth subject.

15. The method of claim 1, wherein the credential for the second subject is a first credential for the second subject, the method further comprising:
in response to detecting the second subject within the area, enabling, via a second credential for the second subject, another service different from the service.

16. The method of claim 1, further comprising:
after enabling the service, detecting, via the one or more input devices, an input corresponding to the service; and
in response to detecting the input corresponding to the service, displaying, via the one or more display generation components, one or more indications of content accessible through the service.

17. A non-transitory computer-readable storage medium storing one or more programs configured to be executed by one or more processors of a computer system that is in communication with one or more input devices and one or more display generation components, the one or more programs including instructions for:
detecting, via the one or more input devices, a first subject within an area;
while detecting the first subject within the area, displaying, via the one or more display generation components, content corresponding to the first subject;
while displaying the content corresponding to the first subject, detecting, via the one or more input devices, a second subject within the area, wherein the second subject is different from the first subject; and
in response to detecting the second subject within the area and while maintaining display of the content corresponding to the first subject, enabling, using a credential for the second subject, a service.

18. A computer system configured to communicate with one or more input devices and one or more display generation components, the computer system comprising:
one or more processors; and
memory storing one or more programs configured to be executed by the one or more processors, the one or more programs including instructions for:
detecting, via the one or more input devices, a first subject within an area;
while detecting the first subject within the area, displaying, via the one or more display generation components, content corresponding to the first subject;
while displaying the content corresponding to the first subject, detecting, via the one or more input devices, a second subject within the area, wherein the second subject is different from the first subject; and
in response to detecting the second subject within the area and while maintaining display of the content corresponding to the first subject, enabling, using a credential for the second subject, a service.
